(19) United States
(12) Patent Application Publication
(10) Pub. No.: US 2024/0226616 A1
(43) Pub. Date: Jul. 11, 2024

(54) RESPIRATOR

(71) Applicant: 3M INNOVATIVE PROPERTIES COMPANY, St. Paul, MN (US)

(72) Inventors: Christopher R. Kokaisel, Woodbury, MN (US); David M. Castiglione, Hudson, WI (US); Austin D. Groth, Minneapolis, MN (US); Jennifer A. Chaisson, Ontario (CA); Stephen R. Alexander, Stillwater, MN (US); Duane D. Fansler, Dresser, WI (US); Jay A. Esch, River Falls, WI (US); James P. Endle, New Richmond, WI (US); Peter J. Fritz, West Lakeland Township, MN (US)

(21) Appl. No.: 18/406,723

(22) Filed: Jan. 8, 2024

Related U.S. Application Data
(60) Provisional application No. 63/479,057, filed on Jan. 9, 2023.

(51) Int. Cl. A62B 23/02; A62B 9/04

(52) U.S. Cl. CPC A62B 23/025; A62B 9/04

(57) ABSTRACT

A respirator is described that includes a mask body and at least one housing directly or indirectly coupled to the mask body. The at least one housing includes a pair of slots spaced apart from each other, a cantilevered snap feature disposed between the pair of slots, and a latch connected to the cantilevered snap feature. The respirator further includes at least one cover movably coupled to the at least one housing and including a pair of arms. Each of the pair of arms is disposed adjacent to a corresponding slot from the pair of slots and includes a wide end portion. The at least one cover further includes an elongate member extending between the pair of arms and connected to the wide end portion of each of the pair of arms. The elongate member is at least partially received through each of the pair of slots.

### TECHNICAL FIELD

The present disclosure generally relates to a respirator.

### BACKGROUND

Personal protective equipment (PPE), such as respirators, are often used for cleaning air to be breathed by a user. For example, half mask respirators are used by workers in industrial settings to reduce inhalation of harmful gases. Respirators are also used by health care professionals to reduce spread of harmful pathogens. The most commonly used respirators are generally regarded as disposable and extended or repeated use of such respirators is not recommended by health agencies. Such respirators may not include replaceable filter elements, are not suited for disinfection, and/or are not designed to limit bioburden accumulation.

Reusable respirators are known in the art that allow for the replacement of filter elements. However, there is a need to identify alternative methods for meeting PPE demand. Respirator designs that may be easily manufactured and may allow for reuse with existing series production filter elements as well as integration of new custom filter elements may be desirable.

### SUMMARY

In a first aspect, a respirator is described. The respirator includes a mask body defining a breathable zone for a user. The respirator further includes at least one housing directly or indirectly coupled to the mask body. The at least one housing is disposed in fluid communication with the breathable zone of the mask body. The at least one housing includes a pair of slots spaced apart from each other. Each of the pair of slots includes a first slot end and a second slot end. The at least one housing further includes a cantilevered snap feature disposed between the pair of slots. The at least one housing further includes a latch connected to the cantilevered snap feature and configured to move the cantilevered snap feature upon application of a force on the latch. The respirator further includes at least one cover movably coupled to the at least one housing and including a plurality of cover openings therethrough. Each of the plurality of cover openings is configured to allow a breathable gas to flow therethrough. The at least one cover further includes a pair of arms. Each of the pair of arms is disposed adjacent to a corresponding slot from the pair of slots. Each of the pair of arms includes a wide end portion including a maximum width greater than a maximum width of the corresponding slot. The at least one cover further includes an elongate member extending between the pair of arms and connected to the wide end portion of each of the pair of arms. The elongate member is at least partially received through each of the pair of slots. The at least one housing and the at least one cover are configured to removably receive at least one filter component therebetween, such that the breathable gas passes through the at least one filter component before entering the breathable zone.

In a second aspect, a respiratory system is described. The respiratory system includes the respirator of the first aspect and at least one filter component removably received between the at least one housing and the at least one cover of the respirator.

In a third aspect, a respirator is described. The respirator includes a mask body defining a breathable zone for a user. The respirator further includes at least one housing directly or indirectly coupled to the mask body. The at least one housing is disposed in fluid communication with the breathable zone of the mask body. The respirator further includes at least one cover removably coupled to the at least one housing and including a plurality of cover openings therethrough. Each of the plurality of cover openings is configured to allow a breathable gas to flow therethrough. The at least one housing and the at least one cover are configured to removably receive at least one filter component therebetween, such that the breathable gas passes through the at least one filter component before entering the breathable zone. At least one of the mask body and the at least one housing includes one or more annular barbs configured to form an annular barbed seal between the mask body and the at least one housing.

In a fourth aspect, a respiratory system is described. The respiratory system includes the respirator of the third aspect and at least one filter component removably received between the at least one housing and the at least one cover of the respirator.

In a fifth aspect, a respirator is described. The respirator includes a mask body defining a breathable zone for a user. The respirator further includes at least one housing disposed in fluid communication with the breathable zone of the mask body. The respirator further includes a hub detachably coupled to each of the mask body and the at least one housing, such that the at least one housing is indirectly coupled to the mask body via the hub. The respirator further includes at least one cover movably or removably coupled to the at least one housing and including a plurality of cover openings therethrough. Each of the plurality of cover openings is configured to allow a breathable gas to flow therethrough. The at least one housing and the at least one cover are configured to removably receive at least one filter component therebetween, such that the breathable gas passes through the at least one filter component before entering the breathable zone.

In a sixth aspect, a respiratory system is described. The respiratory system includes the respirator of the fifth aspect and at least one filter component removably received between the at least one housing and the at least one cover of the respirator.

In a seventh aspect, the respirator includes a mask body defining a breathable zone for a user. The respirator further includes at least one housing directly coupled to the mask body. The at least one housing is disposed in fluid communication with the breathable zone of the mask body. The respirator further includes at least one cover including a plurality of cover openings therethrough. Each of the plurality of cover openings is configured to allow a breathable gas to flow therethrough. The respirator further includes a living hinge pivotally coupling the at least one cover to the at least one housing. The at least one housing and the at least one cover are configured to removably receive at least one filter component therebetween, such that the breathable gas passes through the at least one filter component before entering the breathable zone. The mask body, the at least one housing, and the at least one cover are integrally formed as a unitary part. The at least one housing includes a first wall disposed adjacent to and coupled to the mask body. The first wall includes a plurality of first openings therethrough. The plurality of first openings fluidly communicate with the breathable zone. The at least one housing further includes a second wall spaced apart from the first wall and facing the at least one cover. The second wall includes a plurality of second openings therethrough. The at least one housing further includes a third wall disposed between the first wall and the second wall. The third wall is devoid of any openings. The at least one housing further includes a first side wall extending between the first wall and the third wall. The first side wall defines a plurality of side openings therethrough. The at least one housing further includes a second side wall extending between the second wall and the third wall. The second side wall is devoid of any openings. The at least one housing further includes a fluid conduit extending between the at least one housing and the mask body. The first wall, the third wall, and the first side wall define a first chamber therebetween. The plurality of first openings of the first wall fluidly communicate the first chamber with the breathable zone. The first chamber is configured to removably receive a first filter component therein. The breathable gas enters the first chamber through the plurality of side openings, passes through the first filter component, and then enters the breathable zone through the plurality of first openings. The second wall, the third wall, and the second side wall define a second chamber therebetween fluidly separated from the first chamber by the third wall. The fluid conduit fluidly communicates the second chamber with the breathable zone. The second wall and the at least one cover removably receive a second filter component therebetween. The breathable gas passes through the plurality of cover openings and the second filter component, enters the second chamber, and then enters the breathable zone through the fluid conduit.

In an eighth aspect, a respiratory system is described. The respiratory system includes the respirator of the seventh aspect and at least one filter component removably received between the at least one housing and the at least one cover of the respirator.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic front view of a respiratory system, according to an embodiment of the present disclosure;

FIG. 2 is a schematic perspective view of the respiratory system, according to an embodiment of the present disclosure;

FIGS. 3A and 3B are schematic front and rear perspective views, respectively, of the respiratory system in an uncoupled state, according to an embodiment of the present disclosure;

FIG. 4 is a schematic exploded perspective view of the respiratory system, according to an embodiment of the present disclosure;

FIG. 5A is a schematic sectional side view of the respiratory system in a coupled state, according to an embodiment of the present disclosure;

FIG. 5B is an enlarged schematic view of a section X1 of the respiratory system shown in

FIG. 5A, according to an embodiment of the present disclosure;

FIGS. 6A and 6B are schematic rear perspective views of the respiratory system in the coupled state and a detached state, respectively, according to another embodiment of the present disclosure;

FIG. 7 is a schematic perspective view of a respiratory system, according to another embodiment of the present disclosure;

FIGS. 8A and 8B are schematic front and rear perspective views, respectively, of the respiratory system of FIG. 7 in an uncoupled state, according to an embodiment of the present disclosure;

FIG. 9 is a schematic exploded perspective view of the respiratory system of FIG. 7, according to an embodiment of the present disclosure;

FIG. 10A is a schematic sectional side view of the respiratory system of FIG. 7, according to an embodiment of the present disclosure;

FIG. 10B is an enlarged schematic view of a section X2 of the respiratory system shown in FIG. 10A, according to an embodiment of the present disclosure;

FIG. 11A is an enlarged schematic perspective view of a pivot connection of the respiratory system of FIG. 7, according to an embodiment of the present disclosure;

FIG. 11B is an enlarged schematic exploded perspective view of the pivot connection, according to an embodiment of the present disclosure;

FIG. 11C is an enlarged schematic sectional side view of the pivot connection, according to an embodiment of the present disclosure;

FIG. 12 is a schematic perspective view of the pivot connection, according to another embodiment of the present disclosure;

FIG. 13A is a schematic perspective view of a respiratory system, according to another embodiment of the present disclosure;

FIG. 13B is a schematic perspective view of the respiratory system of FIG. 13A in an uncoupled state, according to an embodiment of the present disclosure;

FIGS. 14A and 14B are schematic front and rear exploded perspective views, respectively, of the respiratory system of FIG. 13A, according to an embodiment of the present disclosure;

FIG. 15A is a schematic sectional side view of the respiratory system taken along a section line A-A′ shown in FIG. 13A, according to an embodiment of the present disclosure;

FIG. 15B is an enlarged schematic view of a section X3 of the respiratory system shown in FIG. 15A, according to an embodiment of the present disclosure;

FIGS. 16A and 16B are schematic front and rear perspective views, respectively, of a respiratory system, according to another embodiment of the present disclosure;

FIG. 17 is a schematic rear perspective view of the respiratory system of FIG. 16B in an uncoupled state, according to an embodiment of the present disclosure;

FIG. 18 is a schematic rear exploded perspective view of the respiratory system of FIG. 16B, according to an embodiment of the present disclosure;

FIG. 19 is a schematic sectional side view of the respiratory system of FIG. 16A, according to an embodiment of the present disclosure;

FIG. 20 is a schematic perspective view of a respiratory system, according to another embodiment of the present disclosure;

FIGS. 21A and 21B are schematic front and rear perspective views, respectively, of a respirator of the respiratory system of FIG. 20, according to an embodiment of the present disclosure;

FIG. 22 is a schematic perspective view of a respiratory system, according to another embodiment of the present disclosure;

FIGS. 23A and 23B are schematic front and rear exploded perspective views, respectively, of the respiratory system of FIG. 22, according to an embodiment of the present disclosure;

FIG. 24 is a schematic perspective view of a respiratory system, according to another embodiment of the present disclosure;

FIGS. 25A and 25B are schematic front and rear exploded perspective views, respectively, of the respirator of the respiratory system of FIG. 24, according to an embodiment of the present disclosure;

FIG. 26 is a schematic sectional side view of the respiratory system of FIG. 24, according to an embodiment of the present disclosure;

FIG. 27A is a schematic perspective view of at least one strap of the respiratory system of FIG. 24, according to an embodiment of the present disclosure;

FIG. 27B is a schematic perspective view of the at least one strap with some components not shown, according to an embodiment of the present disclosure;

FIG. 28 is a schematic perspective view of a respiratory system, according to another embodiment of the present disclosure;

FIGS. 29A and 29B are schematic front and rear exploded perspective views, respectively, of the respiratory system of FIG. 28, according to an embodiment of the present disclosure;

FIG. 30 is a schematic sectional side view of the respiratory system of FIG. 28, according to an embodiment of the present disclosure;

FIG. 31 is a schematic perspective view of a respiratory system, according to another embodiment of the present disclosure;

FIG. 32A is a schematic sectional side view of the respiratory system of FIG. 31, according to an embodiment of the present disclosure;

FIG. 32B is an enlarged schematic view of a section X4 of the respiratory system shown in FIG. 32A, according to an embodiment of the present disclosure;

FIG. 32C is an enlarged schematic view of a section X5 of the respiratory system shown in FIG. 32A, according to an embodiment of the present disclosure; and

FIGS. 33A and 33B are schematic front and rear perspective sectional views, respectively, of the respiratory system of FIG. 31, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

As used herein, the term “respirator” is used in a generic sense to mean a filtering device that fits over the nose and mouth of a user.

As used herein, the term “filter” generally refers to any medium that is used in conjunction with the respirator and is responsible for filtering ambient air.

As used herein, the term “housing” generally refers to a component that wholly or partially covers, surrounds, or insulates another component.

As used herein, the term “couple” generally includes, but is not limited to, joining, connecting, fastening, linking, or associating two elements integrally or interstitially together.

As used herein, the term “directly coupled” generally means that two elements are directly in contact with each other.

As used herein, the term “indirectly coupled” generally means that a pair of elements are coupled by one or more intermediate elements.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the recitations of numerical ranges by endpoints include all numbers subsumed within that range as well as the endpoints (e.g., 1 to 5 includes 1, 1.5, 2, 2.75, 3, 3.80, 4, 5, etc.).

According to aspects of this disclosure, a respirator includes a mask body defining a breathable zone for a user. The respirator further includes at least one housing directly or indirectly coupled to the mask body. The at least one housing is disposed in fluid communication with the breathable zone of the mask body. The at least one housing includes a pair of slots spaced apart from each other. Each of the pair of slots includes a first slot end and a second slot end. The at least one housing further includes a cantilevered snap feature disposed between the pair of slots. The at least one housing further includes a latch connected to the cantilevered snap feature and configured to move the cantilevered snap feature upon application of a force on the latch. The respirator further includes at least one cover movably coupled to the at least one housing and including a plurality of cover openings therethrough. Each of the plurality of cover openings is configured to allow a breathable gas to flow therethrough. The at least one cover further includes a pair of arms. Each of the pair of arms is disposed adjacent to a corresponding slot from the pair of slots. Each of the pair of arms includes a wide end portion including a maximum width greater than a maximum width of the corresponding slot. The at least one cover further includes an elongate member extending between the pair of arms and connected to the wide end portion of each of the pair of arms. The elongate member is at least partially received through each of the pair of slots. The at least one housing and the at least one cover are configured to removably receive at least one filter component therebetween, such that the breathable gas passes through the at least one filter component before entering the breathable zone.

The respirator of the present disclosure may allow the at least one filter component to be removably received between the at least one housing and the at least one cover, thereby enabling the respirator to be reused by replacing the at least one filter component. Further, a variety of filter components that are suitable for different applications may be used with a common design of the respirator. Additionally, the respirator of the present disclosure may be additively manufactured in whole or in part, and may enable the respirator to be readily printed across multiple commercial printer platforms.

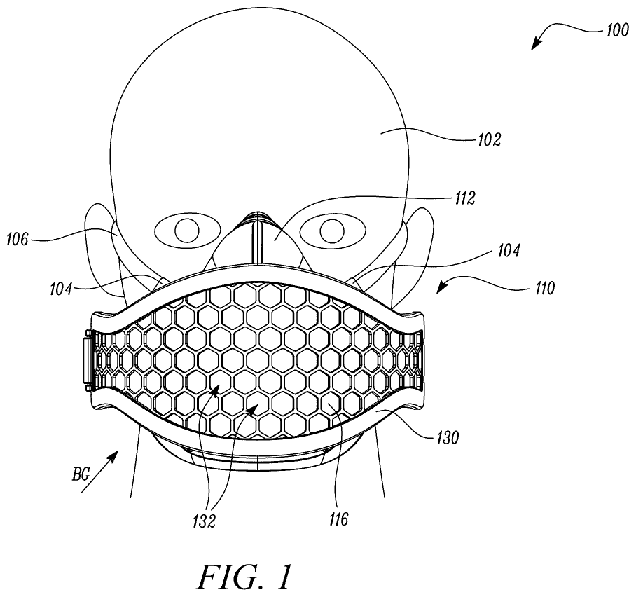

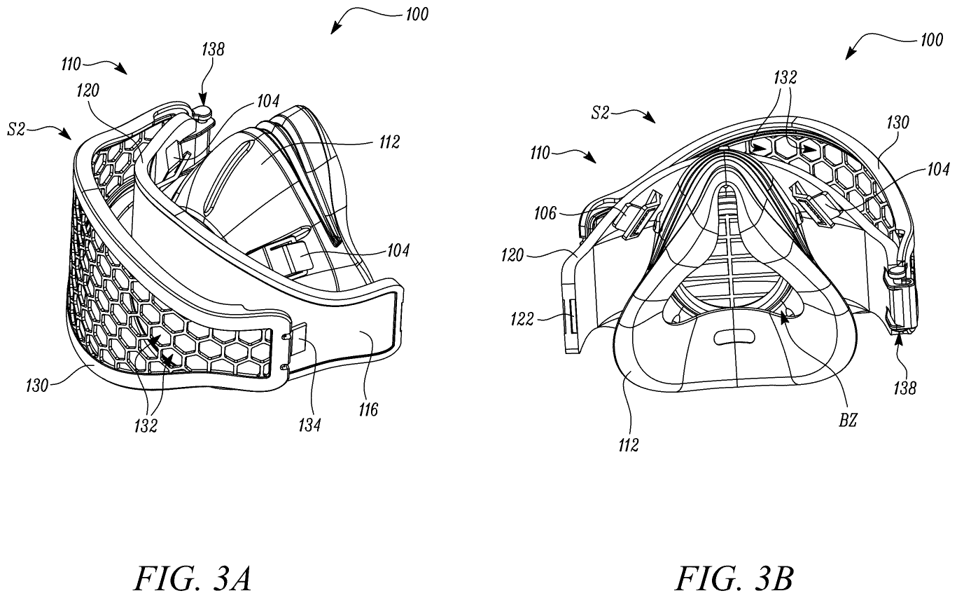

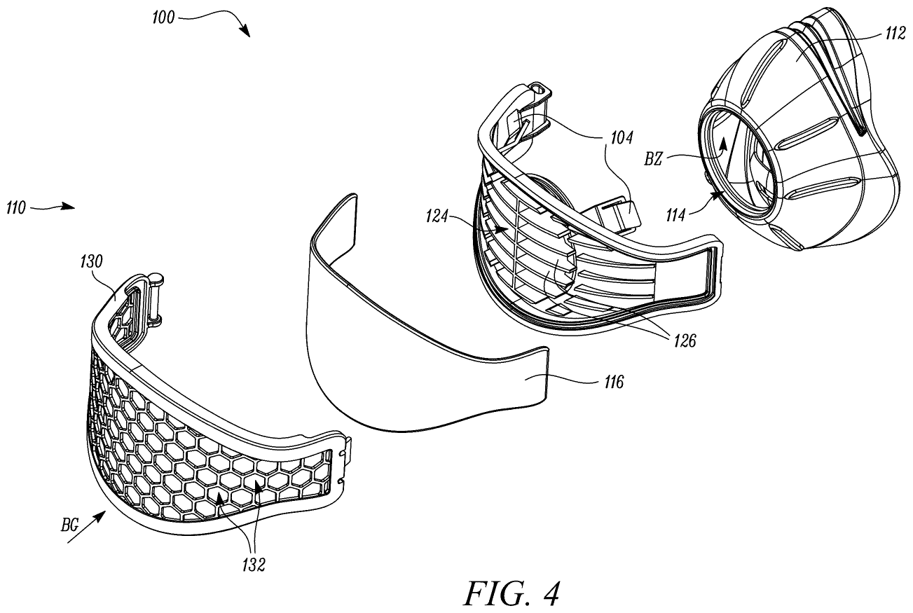

Referring now to Figures, FIG. 1 is a schematic view of a respiratory system 100. The respiratory system 100 includes a respirator 110. The respirator 110 includes a mask body 112 defining a breathable zone BZ (shown in FIGS. 3B and 4) for a user 102. Specifically, the respirator 110 is intended to be worn on the face by the user 102, such that the breathable zone BZ (shown in FIGS. 3B and 4) is defined between the mask body 112 and the face of the user 102. In some examples, the mask body 112 may be designed to form a seal at its periphery with the face of the user 102. Specifically, the mask body 112 may be configured to cover the nose and mouth of the user 102 in a sealing manner. In some examples, the mask body 112 may cover substantially the entire face of the user 102.

In some examples, the respiratory system 100 may be used by emergency personnel, e.g., firefighters, law enforcement, medical personnel, first responders, paramedics, or other personnel working in potentially hazardous environments, e.g., chemical, biological, or nuclear environments, fires, or other physical environments, e.g., construction sites, mining sites, or manufacturing sites.

In some examples, the respiratory system 100 may be a part of a personal protective equipment (PPE). Examples of PPE may include, but are not limited to, respiratory protection equipment (including disposable respirators, reusable respirators, powered air purifying respirators, and supplied air respirators), protective eyewear, such as visors, goggles, filters or shields (any of which may include augmented reality functionality), protective headwear, such as hard hats, hoods or helmets, hearing protection (including ear plugs and ear muffs), protective shoes, protective gloves, other protective clothing, such as coveralls and aprons, protective articles, such as sensors, safety tools, detectors, global positioning devices, mining cap lamps, fall protection harnesses, self-retracting lifelines, exoskeletons, heating and cooling systems, gas detectors, and any other suitable gear configured to protect the user 102 from injury.

In some examples, the respirator 110 may be fabricated, for instance, from a flexible material, such as rubber, silicon, foam, plastic, and/or the like. In some examples, the respirator 110 may be formed of a material that is selected to be substantially impermeable to airborne environmental hazards that the respiratory system 100 may be designed to offer a barrier to. In some examples, the respirator 110 may be produced from additive manufacturing techniques in whole or in part.

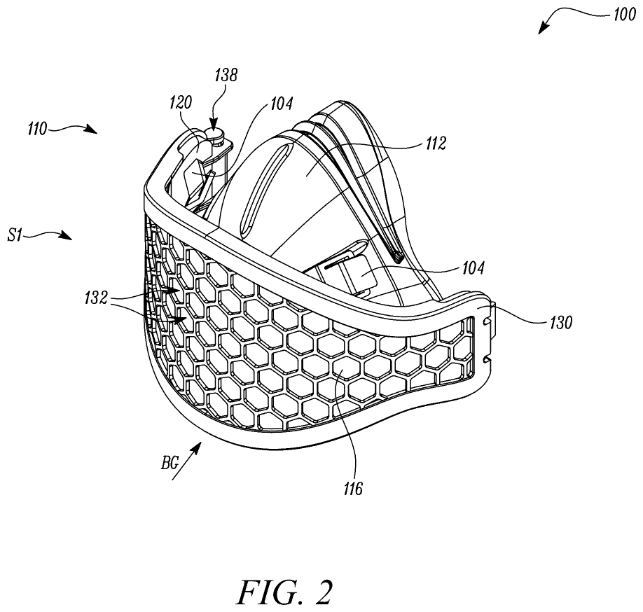

FIG. 2 is a schematic perspective view of the respiratory system 100. Referring now to FIGS. 1 and 2, the respirator 110 further includes at least one housing 120 directly or indirectly coupled to the mask body 112. The at least one housing 120 is disposed in fluid communication with the mask body 112. In some examples, the at least one housing 120 is curved, such that the at least one housing 120 is aligned with the face of the user 102. In some examples, the at least one housing 120 includes at least one strap 104 configured to be coupled to a head harness 106 worn by the user 102.

In some examples, the at least one strap 104 may be affixed to the at least one housing 120. In some examples, the at least one strap 104 and the head harness 106 provide a means by which the user 102 is able to forcibly bring the respirator 110 into contact with the face of the user 102 to effect a seal therewith. In some examples, the head harness 106 may be elasticized to ensure a continuing seal, notwithstanding movement of the user 102. In some examples, the head harness 106 may include clamps that may allow the respirator 110 to be adjusted for loose fit on the face of the user 102. In the illustrated embodiment of FIGS. 1 and 2, the at least one strap 104 includes a pair of straps 104 disposed proximal to opposing ends of the respirator 110. However, it should be understood that the at least one housing 120 may include any number of straps 104.

In some examples, the respiratory system 100 may further include accessories, such as voice emitters, filtering components, etc. For example, voice emitters may be mounted on the respirator 110 to amplify the voice of the user 102 to facilitate communication with other individuals and help provide intelligible speech transmittance through the respirator 110. In some examples, the respiratory system 100 may further include a voice communication system that provides, for example, voice amplification, transmission and/or radio communication functionality.

The respiratory system 100 further includes at least one cover 130 movably coupled to the at least one housing 120 and including a plurality of cover openings 132 therethrough. In some examples, the at least one cover 130 is pivotally coupled to the at least one housing 120. In some examples, the at least one cover 130 may have a similar shape as that of the at least one housing 120. Each of the plurality of cover openings 132 is configured to allow a breathable gas BG to flow therethrough. The breathable gas BG may be ambient air that may be purified by the respiratory system 100.

The respiratory system 100 further includes at least one filter component 116 removably received between the at least one housing 120 and the at least one cover 130. Specifically, the at least one housing 120 and the at least one cover 130 are configured to removably receive the at least one filter component 116 therebetween, such that the breathable gas BG passes through the at least one filter component 116 before entering the breathable zone BZ (shown in FIGS. 3B and 4). Thus, the user 102 may receive the breathable gas BG after passing through the at least one filter component 116. In some examples, the at least one filter component 116 may have a similar shape as that of the at least one housing 120. In some examples, the at least one filter component 116 is Aura N95 Particulate Filter available from 3M Company, St. Paul, Minn., USA.

In some examples, the at least one housing 120 includes a single housing 120. In some examples, the single housing 120 may be produced using additive manufacturing techniques from a rigid material. In some examples, the single housing 120 is detachably coupled to the mask body 112. In some examples, the at least one housing 120 (i.e., the single housing 220) is directly coupled to the mask body 112. In some examples, the at least one cover 130 further includes a single cover 130. In some examples, the single housing 120 and the single cover 130 are configured to removably receive the at least one filter component 116 therebetween. In the illustrated embodiment of FIGS. 1 and 2, the single housing 120 and the single cover 130 removably receive a single filter component 116 therebetween. The term “single housing 120” is interchangeably referred to hereinafter as “the housing 120”. The term “single cover 130” is interchangeably referred to hereinafter as “the cover 130”.

In some examples, the single cover 130 is pivotally coupled to the single housing 120. In some examples, the single cover 130 is further configured to be snap-fitted to the single housing 120. In some examples, the at least one cover 130 is stationary relative to the at least one housing 120 in a coupled state S1. In some examples, in the coupled state C1, the at least one cover 130 is snap-fitted to the at least one housing 120. In some examples, the at least one cover 130 is pivotable relative to the at least one housing 120 in an uncoupled state S2 (shown in FIGS. 3A and 3B). In some examples, the single cover 130 pivots relative to the single housing 120 through a pivot connection 138. However, it should be understood that the single cover 130 may be coupled to the single housing 120 through any other suitable coupling mechanism.

FIGS. 3A and 3B are schematic front and rear perspective views, respectively, of the respiratory system 100 in the uncoupled state S2. Referring now to FIGS. 3A and 3B, in some examples, the at least one cover 130 further includes one or more first features 134 (shown in FIG. 3A). In some examples, the at least one housing 120 further includes one or more second features 122 (shown in FIG. 3B) complementary to the one or more first features 134. In some examples, the one the more first features 134 are configured to form a snap-fit connection with the one or more second features 122.

In the illustrated embodiment of FIGS. 3A and 3B, the one or more first features 134 include an elastic tongue and the one or more second features 122 include a groove configured to engage with the elastic tongue in the coupled state S1 (shown in FIG. 2) to form the snap-fit connection. The snap-fit connection may enable the single cover 130 to uncouple from the single housing 120, thereby enabling replacement of the at least one filter component 116 from the single housing 120. FIG. 4 is a schematic exploded perspective view of the respiratory system 100. In some examples, the at least one housing 120 is disposed in fluid communication with the breathable zone BZ of the mask body 112. In some examples, a negative pressure may be generated inside the breathable zone BZ of the mask body 112 due to inhalation of the breathing gas BG by the user 102 (shown in FIG. 1). The negative pressure generated within the breathable zone BZ may draw the breathing gas BG from the outside of the mask body 112 to the inside in response to the breathing of the user 102.

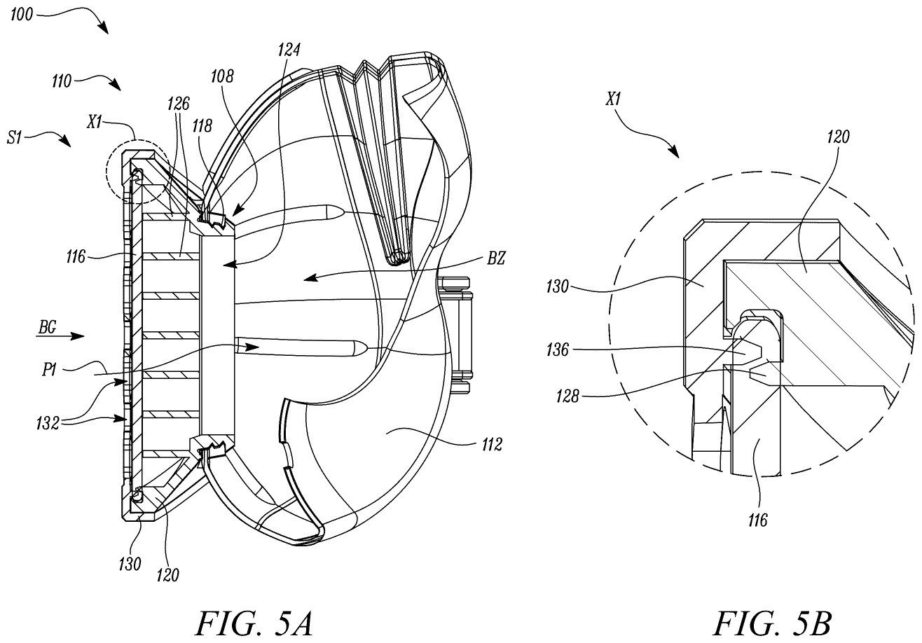

In some examples, the single housing 120 includes a housing opening 124. The mask body 112 includes a mask opening 114 disposed in fluid communication with the housing opening 124. The breathable gas BG may enter the breathable zone BZ of the mask body 112 after passing through the plurality of cover openings 132 of the single cover 130, the at least one filter component 116, the housing opening 124, and the mask opening 114 as indicated by flow P1 shown in FIG. 5A.

In some examples, the at least one housing 120 (i.e., the single housing 120) includes a plurality of ribs 126 configured to engage with the at least one filter component 116. In some examples, the plurality of ribs 126 may be aligned with the housing opening 124 of the single housing 120. The plurality of ribs 126 may have a geometrical shape that enhances flow of the breathable gas BG through the single housing 120.

FIG. 5A is a schematic sectional side view of the respiratory system 100 in the coupled state S1 of the single cover 130. In some examples, at least one of the mask body 112 and the at least one housing 120 (i.e., the single housing 120) includes one or more annular barbs 118 configured to form an annular barbed seal 108 between the mask body 112 and the at least one housing 120 (i.e., the single housing 120). In the illustrated embodiment of FIG. 5A, the mask body 112 includes the one or more annular barbs 118 that engages with corresponding features on the single housing 120 to form the annular barbed seal 108. In some examples, the annular barbed seal 108 may allow a fluid tight connection between the single housing 120 and the mask body 112.

FIG. 5B is an enlarged schematic view of a section X1 (shown in FIG. 5A) of the respiratory system 100. Referring now to FIGS. 5A and 5B, in some examples, the at least one cover 130 (i.e., the single cover 130) further includes a continuous cover knife edge seal 136 configured to engage with the at least one filter component 116. In some examples, the at least one housing 120 (i.e., the single housing 120) further includes a continuous housing knife edge seal 128 spaced apart from the continuous cover knife edge seal 136 and configured to engage with the at least one filter component 116. The continuous cover knife edge seal 136 and the continuous housing knife edge seal 128 may hold the at least one filter component 116 in place between the single housing 120 and the single cover 130.

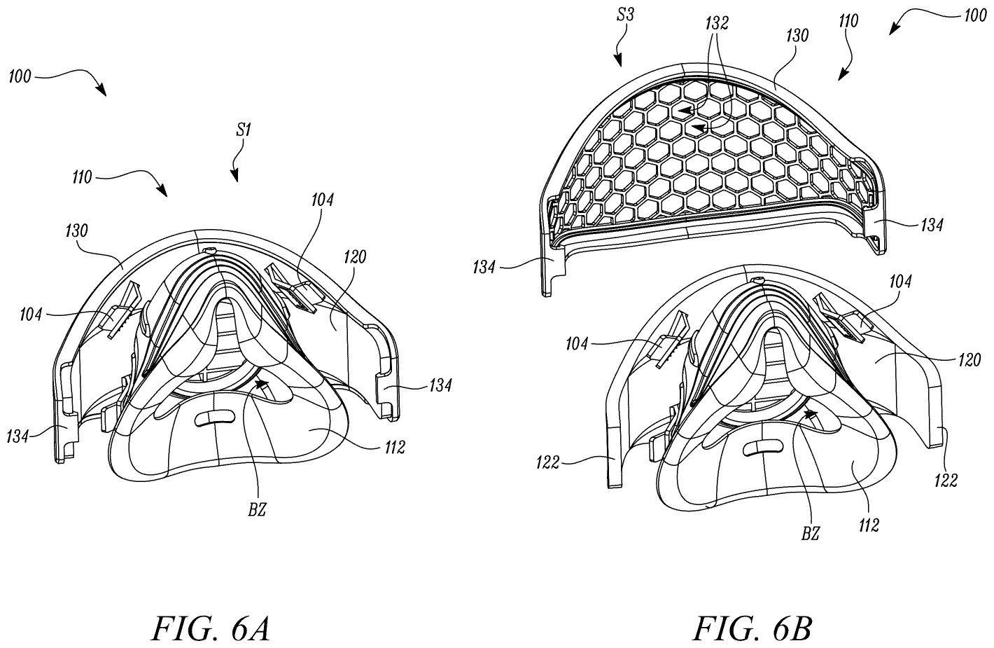

FIGS. 6A and 6B are schematic rear perspective views of the respiratory system 100 in the coupled state S1 and an uncoupled state S3, respectively, according to another embodiment of the present disclosure. In the illustrated embodiments of FIGS. 6A and 6B, the at least one cover 130 (i.e., the single cover 130) is removably coupled to the at least one housing 120 (i.e., the single housing 120). In the uncoupled state S3 (shown in FIG. 6B), the at least one cover 130 (i.e., the single cover 130) is removed from the at least one housing 120 (i.e., the single housing 120). The uncoupled state S3 may therefore correspond to a detached state where the single cover 130 is completely removed or detached from the single housing 120.

Referring now to FIGS. 6A and 6B, in some examples, the at least one cover 130 (i.e., the single cover 130) further includes the one or more first features 134 and the at least one housing 120 (i.e., the single housing 120) further includes the one or more second features 122 complementary to the one or more first features 134. The one the more first features 134 are configured to form the snap-fit connection with the one or more second features 122.

In the illustrated embodiment of FIGS. 6A and 6B, the one or more first features 134 include an elastic tongue and the one or more second features 122 include an edge configured to engage with the elastic tongue in the coupled state S1 (shown in FIG. 6A) to form the snap-fit connection. Thus, the snap-fit connection may allow the single cover 130 to be removed from the single housing 120, thereby enabling replacement of the at least one filter component 116 (shown in FIG. 4). In some examples, the at least one of the mask body 112 and the at least one housing 120 (i.e., the single housing 120) includes the one or more annular barbs 118 (shown in FIG. 5A) configured to form the annular barbed seal 108 (shown in FIG. 5A) between the mask body 112 and the at least one housing 120 (i.e., the single housing 120).

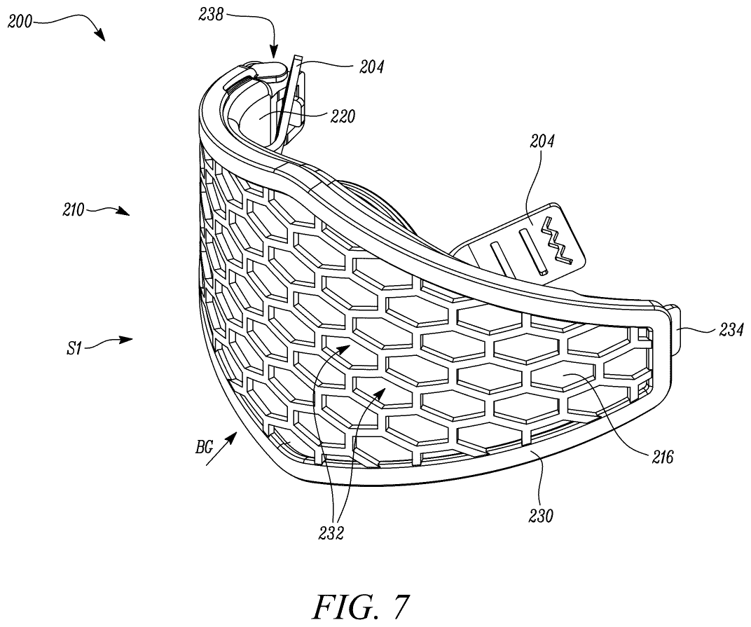

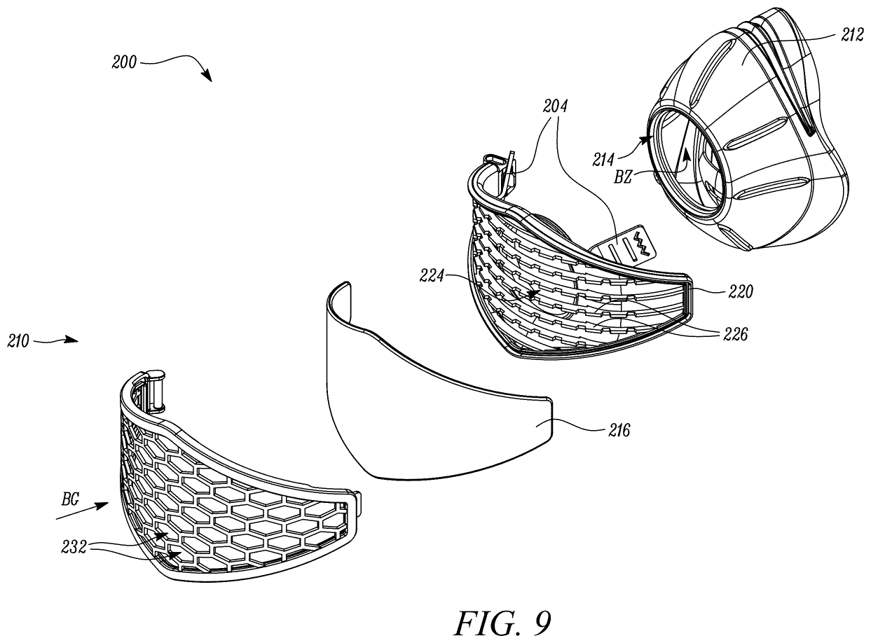

FIG. 7 is a schematic perspective view of a respiratory system 200. The respiratory system 200 may be similar to the respiratory system 100 (shown in FIGS. 1-6B), and equivalent reference numbers are used to indicate similar or identical components. The respiratory system 200 includes a respirator 210. The respirator 210 includes at least one housing 220 directly or indirectly coupled to a mask body 212 (shown in FIG. 9). In some examples, the at least one housing 220 is curved, such that the at least one housing 220 is aligned with the face of a user (e.g., the user 102 shown in FIG. 1).

In the illustrated embodiment of FIG. 7, the at least one housing 220 includes a single housing 220. In some examples, the single housing 220 may be produced using additive manufacturing techniques from a rigid material. In some examples, the at least one housing 220 (i.e., the single housing 220) includes at least one strap 204 configured to be coupled to a head harness (e.g., the head harness 106 shown in FIG. 1) worn by the user. In the illustrated embodiment of FIG. 7, the single housing 220 includes a pair of straps 204. However, it should be understood that the single housing 220 may include any number of straps 204. The term “single housing 220” is interchangeably referred to hereinafter as “the housing 220”. The respirator 210 further includes at least one cover 230 movably coupled to the at least one housing 220 (i.e., the single housing 220) and including a plurality of cover openings 232 therethrough. In some examples, the at least one cover 230 may have a similar shape as that of the at least one housing 220 (i.e., the single housing 220). In some examples, the at least one cover 230 further includes a single cover 230. The term “single cover 230” is interchangeably referred to hereinafter as “the cover 230”.

Each of the plurality of cover openings 232 is configured to allow the breathable gas BG to flow therethrough. In some examples, each of the single housing 220 and the single cover 230 is curved and has a substantially kite-shaped configuration. In the illustrated embodiment of FIG. 7, the at least one cover 230 (i.e., the single cover 230) is movably coupled to the at least one housing 220 (i.e., the single housing 220). In some examples, the single cover 230 is pivotally coupled to the single housing 220 via a pivot connection 238. However, it should be understood that the single cover 230 may be coupled to the single housing 220 through any other suitable coupling mechanism. The respiratory system 200 further includes at least one filter component 216 removably received between the at least one housing 220 (i.e., the single housing 120) and the at least one cover 130 (i.e., the single cover 230). Specifically, the at least one housing 220 (i.e., the single housing 220) and the at least one cover 230 (i.e., the single cover 230) are configured to removably receive the at least one filter component 216 therebetween. In the illustrated embodiment of FIG. 7, the at least one filter component 216 is a single filter component.

In some examples, the at least one cover 230 (i.e., the single cover 230) is stationary relative to the at least one housing 220 (i.e., the single housing 220) in the coupled state S1. In some examples, in the coupled state S1, the at least one cover 230 (i.e., the single cover 230) is snap-fitted to the at least one housing 220 (i.e., the single housing 220). In some examples, the single cover 230 is further configured to be snap-fitted to the single housing 220, thereby restricting a movement of the at least one cover 230 (i.e., the single cover 230) relative to the at least one housing 220 (i.e., the single housing 220).

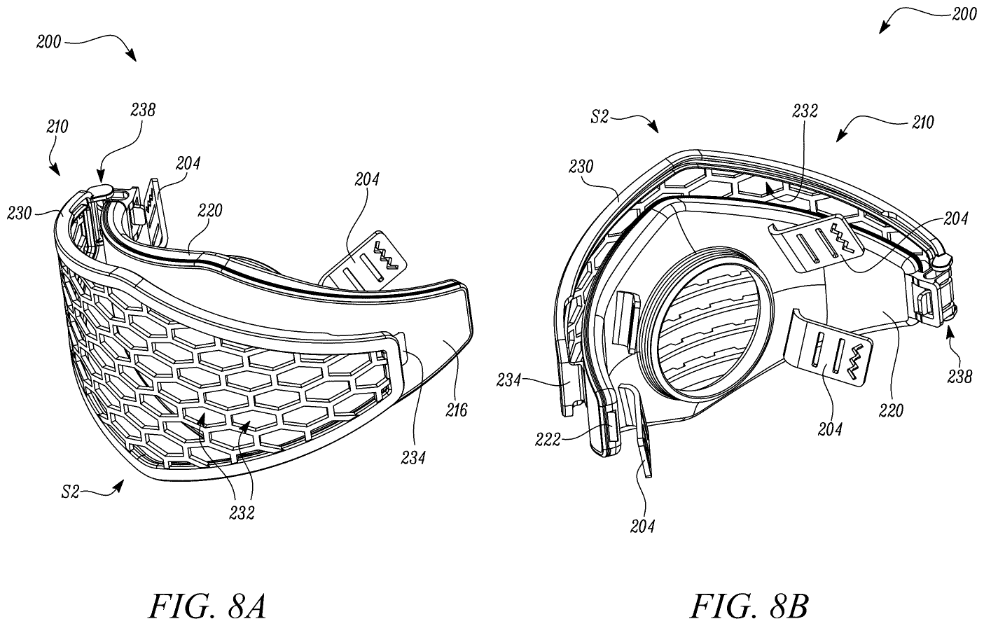

FIGS. 8A and 8B are schematic front and rear perspective views, respectively, of the respiratory system 200 in the uncoupled state S2. In some examples, the at least one cover 230 (i.e., the single cover 230) is pivotable relative to the at least one housing 220 (i.e., the single housing 220) in the uncoupled state S2.

Referring now to FIGS. 8A and 8B, in some examples, the at least one cover 230 (i.e., the single cover 230) further includes one or more first features 234. In some examples, the at least one housing 220 (i.e., the single housing 220) further includes one or more second features 222 (shown in FIG. 8B) complementary to the one or more first features 234. In some examples, the one the more first features 234 are configured to form a snap-fit connection with the one or more second features 222.

In the illustrated embodiment of FIGS. 8A and 8B, the one or more first features 234 include an elastic tongue and the one or more second features 222 include a protrusion configured to engage with the elastic tongue in the coupled state S1 (shown in FIG. 7) to form the snap-fit connection. Thus, the snap-fit connection may allow the single cover 230 to be uncoupled from the single housing 220, thereby enabling replacement of the at least one filter component 216.

FIG. 9 is a schematic exploded perspective view of the respiratory system 200. The respirator 210 includes the mask body 212 defining the breathable zone BZ for a user (e.g., the user 102 shown in FIG. 1). The at least one housing 220 (i.e., the single housing 220) is disposed in fluid communication with the breathable zone BZ of the mask body 212. In some examples, the single housing 220 is detachably coupled to the mask body 212. In some examples, the at least one housing 220 (i.e., the single housing 220) is directly coupled to the mask body 212.

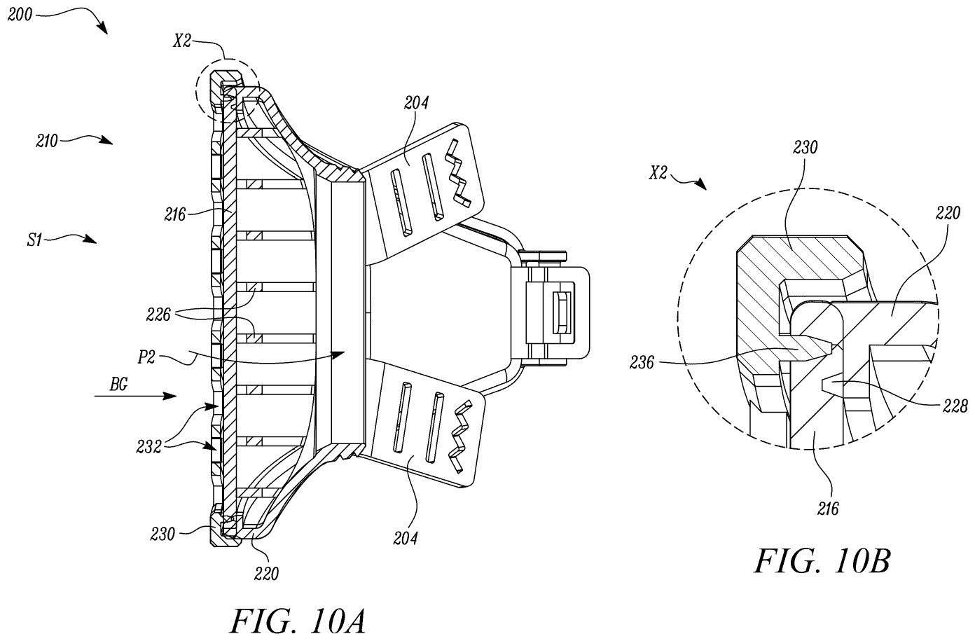

In some examples, the single housing 220 further includes a housing opening 224. The mask body 212 includes a mask opening 214 disposed in fluid communication with the housing opening 224. The breathable gas BG passes through the at least one filter component 216 before entering the breathable zone BZ. In some examples, the breathable gas BG may enter the breathable zone BZ of the mask body 212 after passing through the plurality of cover openings 232 of the single cover 230, the at least one filter component 216, the housing opening 224, and the mask opening 214 as indicated by flow P2 shown in FIG. 10A.

In some examples, the at least one housing 220 (i.e., the single housing 220) further includes a plurality of ribs 226 configured to engage with the at least one filter component 216. In some examples, the plurality of ribs 226 may be aligned with the housing opening 224 of the single housing 220. The plurality of ribs 226 may have a geometrical shape that enhances flow of the breathable gas BG through the single housing 220.

FIG. 10A is a schematic sectional side view of the respiratory system 200 in the coupled state S1 of the single cover 230. In some examples, at least one of the mask body 212 (shown in FIG. 9) and the at least one housing 220 (i.e., the single housing 220) includes one or more annular barbs configured to form an annular barbed seal between the mask body 212 and the at least one housing 220 (i.e., the single housing 120).

FIG. 10B is an enlarged schematic view of a section X2 (shown in FIG. 10A) of the respiratory system 200. Referring now to FIGS. 10A and 10B, in some examples, the at least one cover 230 (i.e., the single cover 230) further includes a continuous cover knife edge seal 236 configured to engage with the at least one filter component 216. In some examples, the at least one housing 220 (i.e., the single housing 220) further includes a continuous housing knife edge seal 228 spaced apart from the continuous cover knife edge seal 236 and configured to engage with the at least one filter component 216. The continuous cover knife edge seal 236 and the continuous housing knife edge seal 228 may hold the at least one filter component 216 in place between the single housing 220 and the single cover 230.

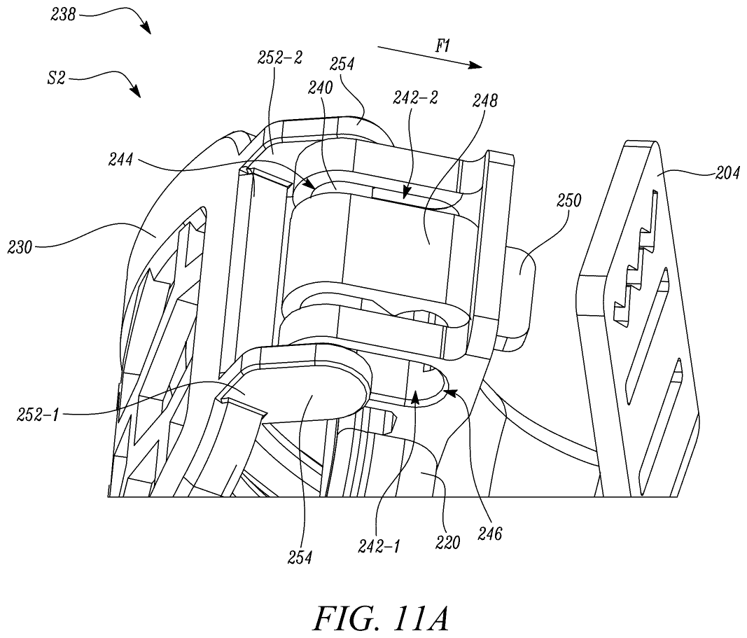

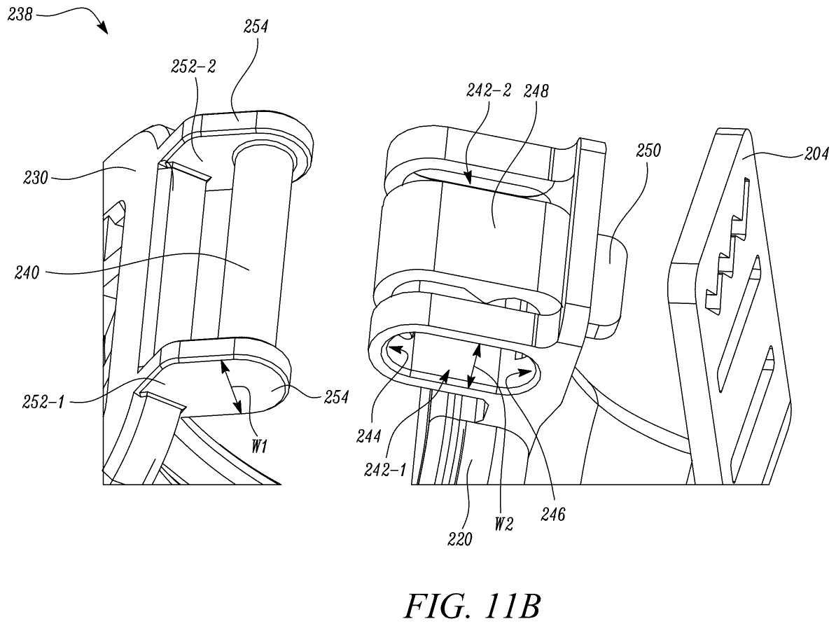

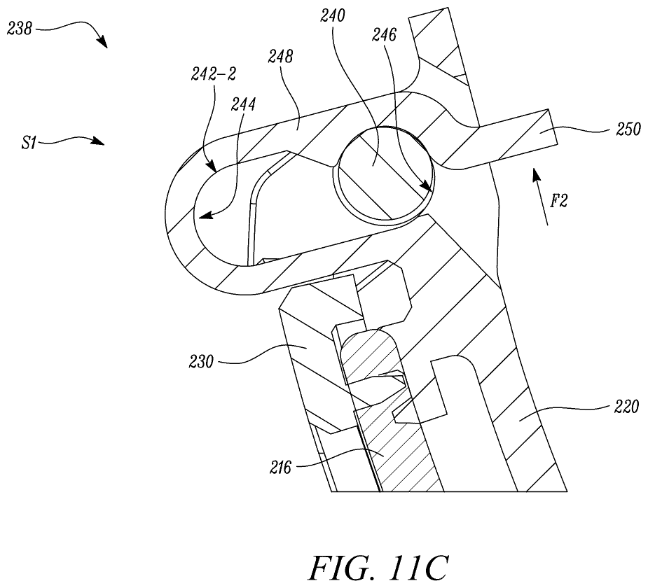

FIG. 11A is an enlarged schematic perspective view of the pivot connection 238. In some examples, the at least one housing 220 (i.e., the single housing 220) includes a pair of slots 242-1, 242-2 (collectively, slots 242) spaced apart from each other. In some examples, the at least one housing 220 (i.e., the single housing 220) further includes a cantilevered snap feature 248 disposed between the pair of slots 242-1, 242-2. In some examples, the at least one housing 220 (i.e., the single housing 220) further includes a latch 250 connected to the cantilevered snap feature 248. In some examples, the at least one cover 230 (i.e., the single cover 230) further includes a pair of arms 252-1, 252-2. Each of the pair of arms 252-1, 252-2 is disposed adjacent to a corresponding slot 242-1, 242-2 from the pair of slots 242. Specifically, the arm 252-1 is disposed adjacent to the slot 242-1 and the arm 252-2 is disposed adjacent to the slot 242-2. In some examples, each of the pair of arms 252-1, 252-2 includes a wide end portion 254. In some examples, the at least one cover 230 (i.e., the single cover 230) further includes an elongate member 240 extending between the pair of arms 252-1, 252-2 and connected to the wide end portion 254 of each of the pair of arms 252-1, 252-2. In some examples, the elongate member 240 is at least partially received through each of the pair of slots 242-1, 242-2. Further, the elongate member 240 is movably received within the pair of slots 242-1, 242-2.

FIG. 11B is an enlarged schematic exploded perspective view of the pivot connection 238. In some examples, the wide end portion 254 of each of the pair of arms 252-1, 252-2 includes a maximum width W1 greater than a maximum width W2 of the corresponding slot 242-1, 242-2. Thus, the wide end portion 254 of each of the pair of arms 252-1, 252-2 mayretain the elongate member 240 within each of the pair of slots 242-1, 242-2.

Referring now to FIGS. 11A and 11B, in some examples, each of the pair of slots 242-1, 242-2 includes a first slot end 244 and a second slot end 246. The elongate member 240 is disposed proximal to the first slot end 244 of each of the pair of slots 242-1, 242-2 in FIG. 11A. Further, FIG. 11A shows the pivot connection 238 in the uncoupled state S2. Additionally, in the uncoupled state S2, the pair of arms 252-1, 252-2 are disposed proximal to the first slot ends 244 of the corresponding slot 242-1, 242-2. In some examples, in the uncoupled state S2, the at least one cover 230 (i.e., the single cover 230) is pivotable relative to the at least one housing 220 (i.e., the single housing 220).

In some examples, the elongate member 240 is configured to be slidably moved along each of the pair of slots 242-1, 242-2 towards the second slot end 246 of each of the pair of slots 242-1, 242-2. Specifically, the elongate member 240 is configured to be slidably moved along each of the pair of slots 242-1, 242-2 upon application of a force F1, thereby moving the at least one cover 230 (i.e., the single cover 230) to the coupled state S1 as shown in FIG. 11C. In some examples, the at least one cover 230 (i.e., the single cover 230) is rotated relative to the at least one housing 220 (i.e., the single housing 220) before application of the force F1, such that the at least one cover 230 (i.e., the single cover 230) is aligned with the at least one housing 220 (i.e., the single housing 220).

FIG. 11C is a schematic sectional side view of the pivot connection 238. Specifically, the FIG. 11C shows the pivot connection 238 in the coupled state S1 of the at least one cover 230 (i.e., the single cover 230). Only the slot 242-2 is shown in FIG. 11C for the purpose of illustration. In some examples, in the coupled state S1, the at least one cover 230 (i.e., the single cover 230) is snap-fitted to the at least one housing 220 (i.e., the single housing 220). Thus, in the coupled state S1, the at least one cover 230 (i.e., the single cover 230) is stationary relative to the at least one housing 220 (i.e., the single housing 220). Further, in the coupled state S1, the elongate member 240 is disposed proximal to the second slot end 246 of each of the pair of slots 242-1, 242-2. Additionally, in the coupled state S1, each of the pair of arms 252-1, 252-2 is disposed adjacent to the second slot end 246 of corresponding slot 242-1, 242-2.

In some examples, upon movement of the elongate member 240 towards the second slot end 246 of each of the pair of slots 242-1, 242-2, the elongate member 240 is snap-fitted to the cantilevered snap feature 248, thereby preventing relative slidable movement between the elongate member 240 and each of the pair of slots 242-1, 242-2. The cantilevered snap feature 248 includes a curved region that snap-fits to the elongate member 240, thereby preventing relative slidable movement between the elongate member 240 and the pair of slots 242-1, 242-2.

In some examples, the latch 250 is configured to move the cantilevered snap feature 248 upon application of a force F2 on the latch 250. In some examples, upon application of the force F2 on the latch 250, the cantilevered snap feature 248 disengages from the elongate member 240, thereby allowing sliding movement of the elongate member 240. In some examples, the latch 250 may allow the curved region of the cantilevered snap feature 248 to disengage from the elongate member 240 upon application of the force F2, thereby allowing sliding movement of the elongate member 240 relative to the pair of slots 242-1, 242-2. Thus, the elongate member 240 may be moved towards the first slot end 244 of each of the pair of slots 242-1, 242-2 upon application of the force F2 on the latch 250. In other words, the at least one cover 230 (i.e., the single cover 230) may be moved to the uncoupled state S2 (shown in FIG. 11A) upon application of the force F2 on the latch 250.

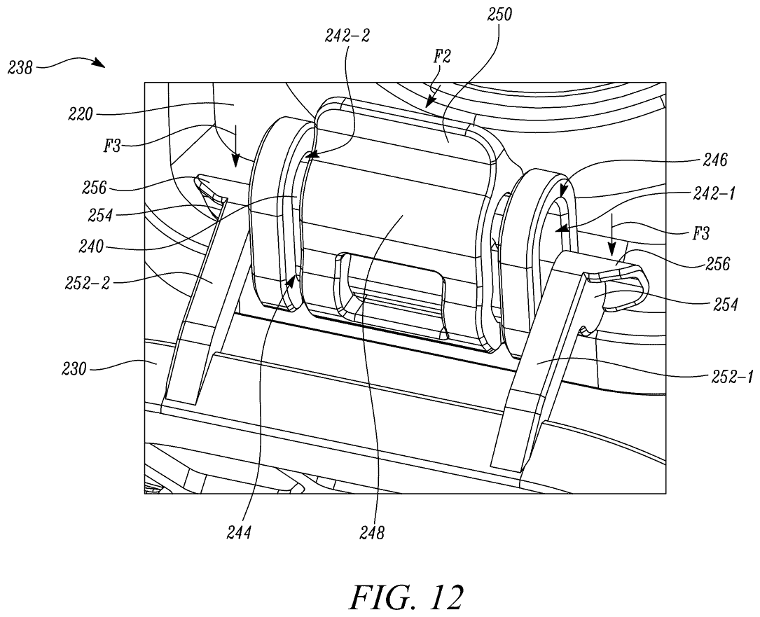

In some examples, the pivot connection 138 (shown in FIGS. 2-3B) is similar to the pivot connection 238 (shown in FIGS. 11A-12).

FIG. 12 is a schematic perspective view of the pivot connection 238, according to another embodiment of the present disclosure. In some examples, the at least one housing 220 (i.e., the single housing 220) includes the pair of slots 242-1, 242-2. In some examples, each of the pair of slots 242-1, 242-2 includes the first slot end 244 and the second slot end 246. In some examples, the at least one housing 220 (i.e., the single housing 220) further includes the cantilevered snap feature 248 disposed between the pair of slots 242. In some examples, the at least one housing 220 (i.e., the single housing 220) further includes the latch 250 connected to the cantilevered snap feature 248.

In some examples, the at least one cover 230 (i.e., the single cover 230) further includes the pair of arms 252-1, 252-2. Each of the pair of arms 252-1, 252-2 is disposed adjacent to a corresponding slot 242-1, 242-2 from the pair of slots 242-1, 242-2. Specifically, the arm 252-1 is disposed adjacent to the slot 242-1 and the arm 252-2 is disposed adjacent to the slot 242-2. In some examples, each of the pair of arms 252-1, 252-2 includes the wide end portion 254. In some examples, the at least one cover 230 (i.e., the single cover 230) further includes the elongate member 240 extending between the pair of arms 252-1, 252-2. The elongate member 240 is at least partially received through each of the pair of slots 242-1, 242-2.

In some examples, the wide end portion 254 of each of the pair of arms 252-1, 252-2 further includes a protrusion 256 configured to receive a force F3 in order to slidably move the elongate member 240 towards the first slot end 244 of each of the pair of slots 242-1, 242-2. Thus, the protrusion 256 may facilitate movement of the elongate member 240 from the second slot end 246 towards the first slot end 244 as the cantilevered snap feature 248 disengages from the elongate member 240 upon application of the force F2 on the latch 250. In other words, the protrusion 256 may provide a means for application of the force F3 for moving the elongate member 240 towards the first slot end 244 upon disengagement of the cantilevered snap feature 248 from the elongate member 240.

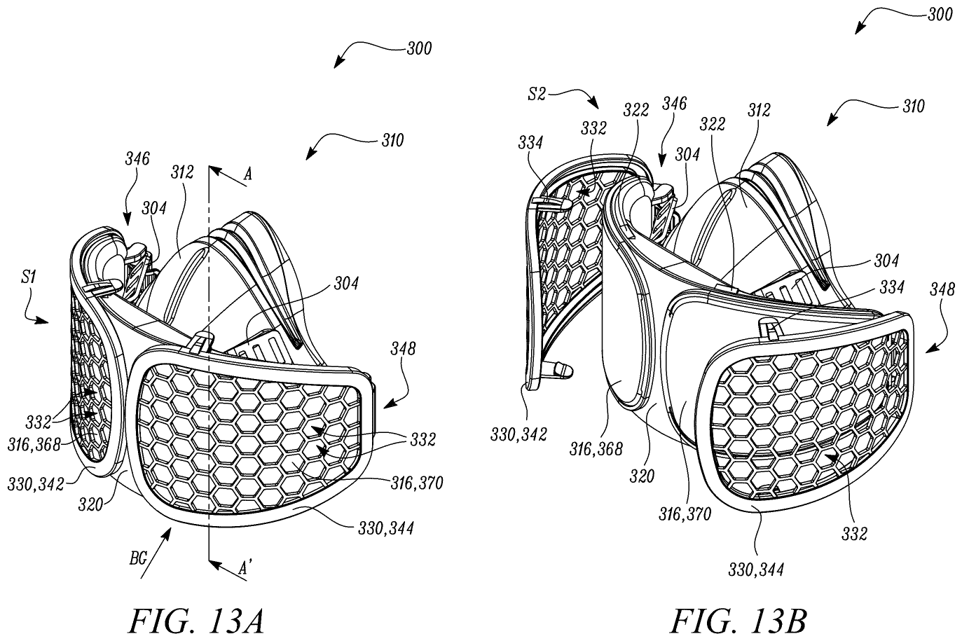

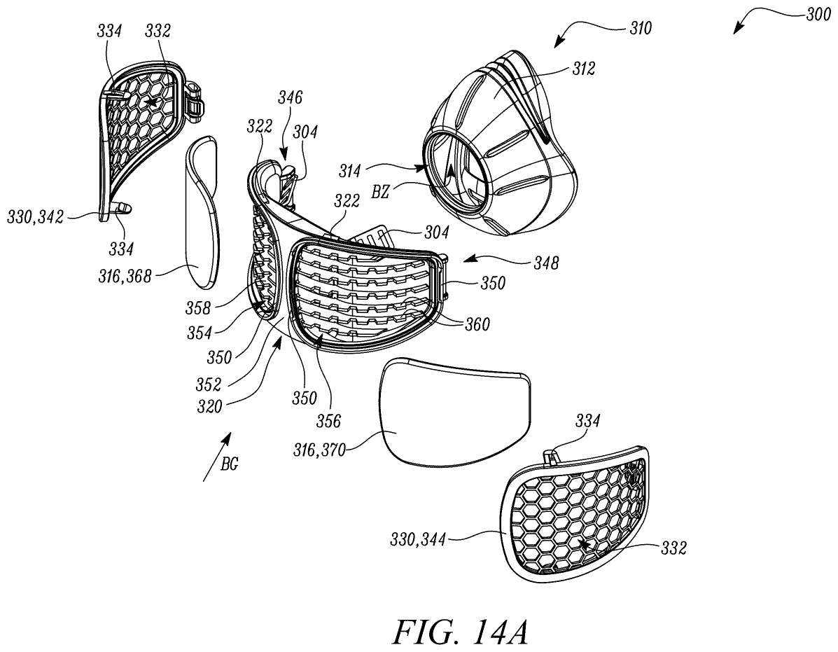

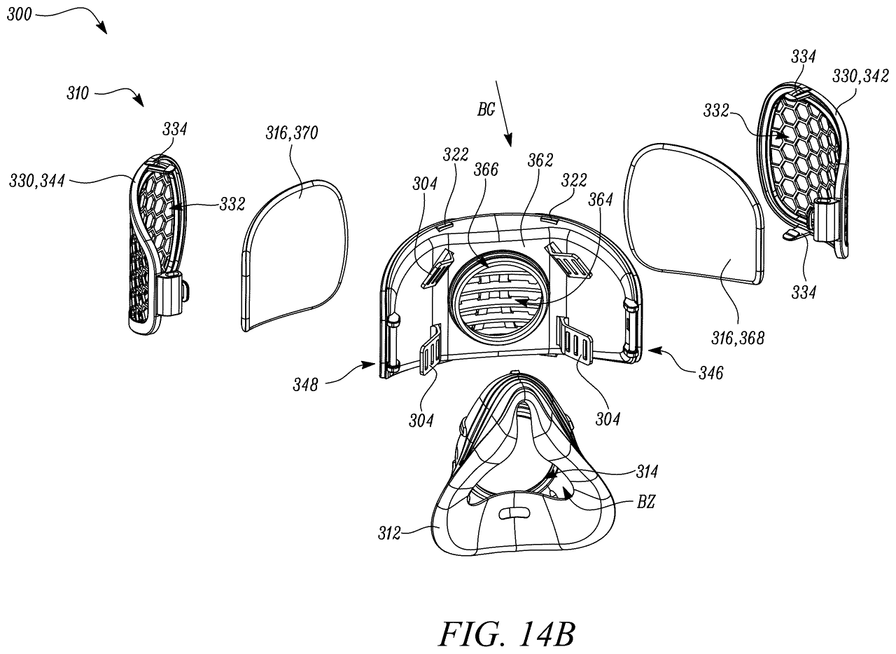

FIG. 13A is a schematic perspective view of a respiratory system 300. The respiratory system 300 may be functionally similar to the respiratory system 100 (shown in FIGS. 1-6B), and equivalent reference numbers are used to indicate similar or identical components. The respiratory system 300 includes a respirator 310. The respirator 310 includes a mask body 312 defining the breathable zone BZ (shown in FIG. 14A) for a user (e.g., the user 102 shown in FIG. 1).

The respirator 310 further includes at least one housing 320 directly or indirectly coupled to the mask body 312. In the illustrated embodiment of FIG. 13A, the at least one housing 320 is directly coupled to the mask body 312. Further, the at least one housing 320 includes a single housing 320 including a curved shape. The curved shape may allow the respirator 310 to be aligned with the face of the user. The term “single housing 320” is interchangeably referred to hereinafter as “the housing 320”.

In some examples, the single housing 320 extends between a first housing end 346 and a second housing end 348 opposite to the first housing end 346. In some examples, the at least one housing 320 (i.e., the single housing 320) includes at least one strap 304 configured to be coupled to a head harness (e.g., the head harness 106 shown in FIG. 1) worn by the user. In the illustrated embodiment of FIG. 13A, the at least one strap 304 includes a pair of straps 304 disposed proximal to the respective first and second housing ends 346, 348. However, it should be understood that the at least one housing 320 may include any number of straps 304.

The respirator 310 further includes at least one cover 330 movably coupled to the at least one housing 320 (i.e., the single housing 320) and including a plurality of cover openings 332 therethrough. In the illustrated embodiment of FIG. 13A, the at least one cover 330 further includes a first cover 342 movably coupled to the at least one housing 320 (i.e., the single housing 320). In some examples, the at least one cover 330 further includes a second cover 344 movably coupled to the at least one housing 320 (i.e., the single housing 320) and spaced apart from the first cover 342.

In some examples, the first cover 342 is substantially similar to the second cover 344. In some examples, each of the first cover 342 and the second cover 344 is curved. In some examples, each of the first cover 342 and the second cover 344 incudes the plurality of cover openings 332 therethrough. In some examples, the single housing 320, the first cover 342, and the second cover 344 are integrally formed as a unitary part. In some examples, the single housing 320, the first cover 342, and the second cover 344 may be produced using additive manufacturing techniques from a rigid material.

In some examples, the at least one cover 330 is pivotally coupled to the at least one housing 320 (i.e., the single housing 320). Specifically, each of the first cover 342 and the second cover 344 is pivotally coupled to the at least one housing 320 (i.e., the single housing 320). In some examples, the first cover 342 is pivotally coupled to the single housing 320 proximal to the first housing end 346. In some examples, the second cover 344 is pivotally coupled to the single housing 320 proximal to the second housing end 348. However, it should be understood that the first cover 342 and the second cover 344 may be coupled to the single housing 320 through any other suitable coupling mechanism. Further, each of the first cover 342 and the second cover 344 is pivotally coupled to the single housing 320 via a pivot connection (e.g., the pivot connection 238 shown in FIGS. 11A-12).

In some examples, the at least one cover 330 (i.e., the first cover 342 and the second cover 344) is stationary relative to the at least one housing 320 (i.e., the single housing 320) in the coupled state S1. In some examples, each of the first cover 342 and the second cover 344 is further configured to be snap-fitted to the single housing 320. Specifically, in the coupled state S1, the at least one cover 330 (i.e., the first cover 342 and the second cover 344) is snap-fitted to the at least one housing 320 (i.e., the single housing 320).

FIG. 13B is a schematic perspective view of the respiratory system 300 in the uncoupled state S2. In some examples, the at least one cover 330 (i.e., the first cover 342 and the second cover 344) is pivotable relative to the at least one housing 320 (i.e., the single housing 320) in the uncoupled state S2.

Referring now to FIGS. 13A and 13B, the respiratory system 300 further includes at least one filter component 316 removably received between the at least one housing 320 (i.e., the single housing 320) and the at least one cover 330. Specifically, the at least one housing 320 (i.e., the single housing 320) and the at least one cover 330 are configured to removably receive the at least one filter component 316 therebetween. In some examples, the at least one filter component 316 is 5N11 N95 Particulate Filter available from 3M Company, St. Paul, Minn., USA.

Further, the first cover 342 and the at least one housing 320 (i.e., the single housing 320) are configured to removably receive a first filter component 368 therebetween. In some examples, the second cover 344 and the at least one housing 320 (i.e., the single housing 320) are configured to removably receive a second filter component 370 therebetween. The at least one filter component 316 therefore includes the first filter component 368 and the second filter component 370.

Each of the plurality of cover openings 332 is configured to allow the breathable gas BG to flow therethrough, such that the breathable gas BG passes through the at least one filter component 316 before entering the breathable zone BZ (shown in FIG. 14). In some examples, the breathable gas BG passes through each of the first filter component 368 and the second filter component 370 before entering the breathable zone BZ (shown in FIG. 14).

In some examples, the at least one cover 330 further includes one or more first features 334. Specifically, each of the first cover 342 and the second cover 344 includes the one or more first features 334. In some examples, the at least one housing 320 (i.e., the single housing 320) includes one or more second features 322 complementary to the one or more first features 334. In some examples, the one the more first features 334 are configured to form a snap-fit connection with the one or more second features 322.

In the illustrated embodiment of FIGS. 13A and 13B, the one or more first features 334 include an elastic tongue and the one or more second features 322 include a protrusion configured to engage with the elastic tongue in the coupled state S1 (shown in FIG. 13A) to form the snap-fit connection. Thus, the snap-fit connection may allow the first cover 342 and the second cover 344 to be uncoupled from the single housing 320, thereby enabling replacement of the respective first filter component 368 and the second filter component 370, respectively.

FIG. 14A is a schematic front exploded perspective view of the respiratory system 300. The at least one housing 320 (i.e., the single housing 320) is disposed in fluid communication with the breathable zone BZ of the mask body 312. In some examples, the single housing 320 is detachably coupled to the mask body 312. In some examples, the mask body 312 includes a mask opening 314 extending therethrough. In some examples, the single housing 320 is detachably coupled to the mask opening 314 of the mask body 312.

In some examples, the single housing 320 further includes a first wall 352 facing each of the first cover 342 and the second cover 344. In some examples, the first wall 352 includes a first opening 354 extending therethrough and at least partially aligned with the first cover 342. In some examples, the first opening 354 is disposed in fluid communication with the breathable zone BZ. In some examples, the first wall 352 further includes a second opening 356 extending therethrough and spaced apart from the first opening 354. In some examples, the second opening 356 is at least partially aligned with the second cover 344. In some examples, the second opening 356 is disposed in fluid communication with the breathable zone BZ. In some examples, the first opening 354 is substantially similar to the second opening 356. Thus, the breathable gas BG passes through each of the first opening 354 and the second opening 356 before entering the breathable zone BZ.

In some examples, a plurality of first projections 358 extend from the first wall 352 and configured to engage with the first filter component 368. In some examples, a plurality of second projections 360 extend from the first wall 352 and configured to engage with the second filter component 370. In some examples, the plurality of first projections 358 are substantially similar to the plurality of second projections 360. In some examples, the plurality of first projections 358 and the plurality of second projections 360 may have a geometrical shape that enhances flow of the breathable gas BG through the single housing 320.

In some examples, the at least one housing 320 (i.e., the single housing 320) further includes at least one ledge 350 configured to removably secure the at least one filter component 316 to the at least one housing 320 (i.e., the single housing 320). In the illustrated embodiment of FIG. 14A, the at least one ledge 350 includes a plurality of ledges 350. The plurality of ledges 350 are configured to removably secure the first filter component 368 and the second filter component 370 to the single housing 320. Specifically, each of the plurality of ledges 350 is in the form of a protrusion that extends from the first wall 352 of the single housing 320 at least partially towards the respective first opening 354 and the second opening 356, thereby securing the first filter component 368 and the second filter component 370 to the single housing 320.

FIG. 14B is a schematic rear exploded perspective view of the respiratory system 300. In some examples, the single housing 320 further includes a second wall 362 opposite to the first wall 352 and facing the mask body 312. Referring now to FIGS. 14A and 14B, in some examples, the first wall 352 (shown in FIG. 14A) and the second wall 362 (shown in FIG. 14B) at least partially define a housing chamber 364 therebetween. In some examples, the housing chamber 364 is disposed in fluid communication with each of the first opening 354 and the second opening 356. In some examples, the breathable gas BG is received within the housing chamber 364 through the first opening 354 and the second opening 356.

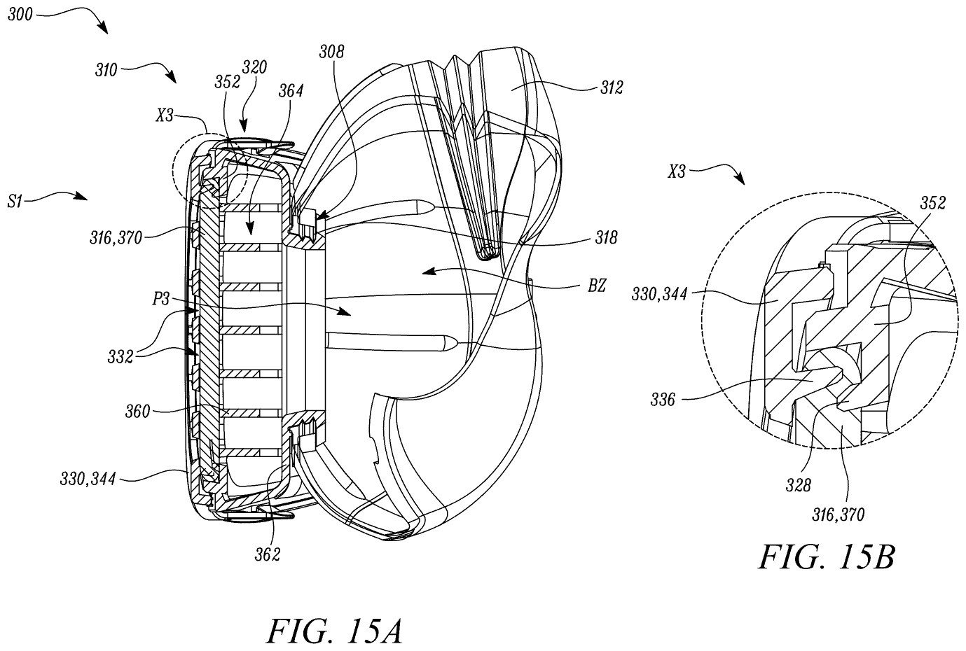

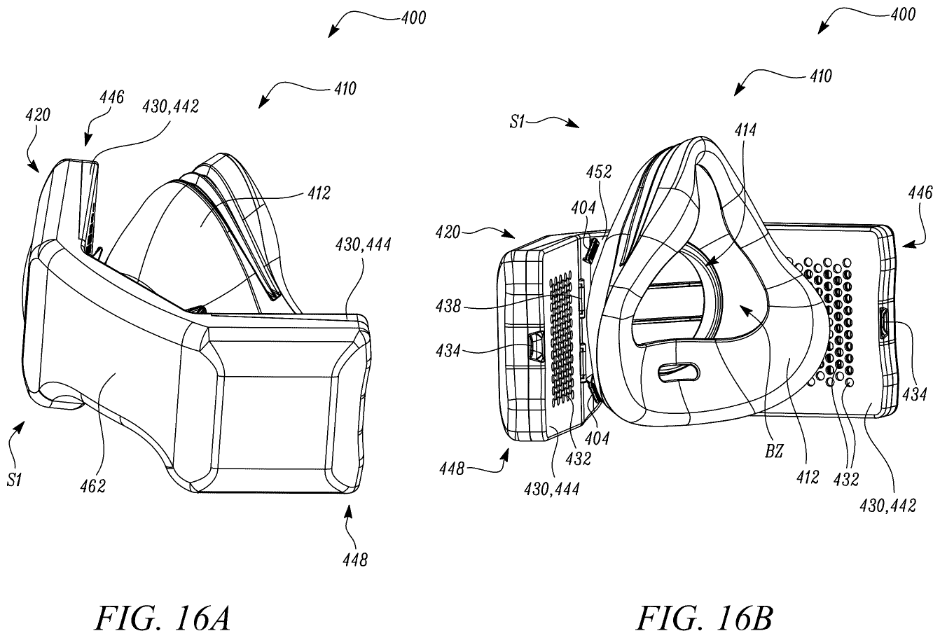

In some examples, the second wall 362 includes a common opening 366 extending therethrough and disposed in fluid communication with the housing chamber 364. In some examples, the mask opening 314 is disposed in fluid communication with the common opening 366 of the second wall 362. Thus, the breathable gas BG enters through the plurality of cover openings 332 of each of the first cover 342 and the second cover 344, passes through each of the first filter component 368 and the second filter component 370, enters the housing chamber 364, and then enters the breathable zone BZ through the common opening 366 and the mask opening 314 as indicated by flow P3 shown in FIG. 15A.

FIG. 15A is a schematic sectional side view of the respiratory system 300 taken along a section line A-A′ shown in FIG. 13A. In some examples, at least one of the mask body 312 and the at least one housing 320 (i.e., the single housing 320) includes one or more annular barbs 318 configured to form an annular barbed seal 308 between the mask body 312 and the at least one housing 320 (i.e., the single housing 320). In the illustrated embodiment of FIG. 15A, the mask body 312 includes the one or more annular barbs 318 that engages with corresponding features on the single housing 320 to form the annular barbed seal 308. In some examples, the annular barbed seal 308 may allow a fluid tight connection between the single housing 320 and the mask body 312.

FIG. 15B is an enlarged schematic view of a section X3 (shown in FIG. 15A) of the respiratory system 300. Referring now to FIGS. 15A and 15B, in some examples, the at least one cover 330 further includes a continuous cover knife edge seal 336 configured to engage with the at least one filter component 316. In some examples, the at least one housing 320 (i.e., the single housing 320) further includes a continuous housing knife edge seal 328 spaced apart from the continuous cover knife edge seal 336 and configured to engage with the at least one filter component 316.

In the illustrated embodiment of FIGS.15A and 15B, the second cover 344 includes the continuous cover knife edge seal 336 configured to engage with the second filter component 370. Further, the single housing 320 further includes the continuous housing knife edge seal 328 configured to engage with the second filter component 370. The continuous cover knife edge seal 336 and the continuous housing knife edge seal 328 may hold the second filter component 370 in place between the single housing 320 and the second cover 344. It should be understood that the features described in FIGS. 15A and 15B with reference to the single housing 320 and the second cover 344 are also applicable to the single housing 320 and the first cover 342.

FIGS. 16A and 16B are schematic front and rear perspective views, respectively, of a respiratory system 400. The respiratory system 400 may be functionally similar to the respiratory system 300 (shown in FIGS. 13A-15), and equivalent reference numbers are used to indicate similar or identical components. Referring now to FIGS. 16A and 16B, the respiratory system 400 includes a respirator 410. The respirator 410 includes a mask body 412 defining the breathable zone BZ (shown in FIG. 16B) for a user (e.g., the user 102 shown in FIG. 1).

The respirator 410 further includes at least one housing 420 directly or indirectly coupled to the mask body 412. In the illustrated embodiment of FIGS. 16A and 16B, the at least one housing 420 is directly coupled to the mask body 412. Further, the at least one housing 420 includes a single housing 420 including a curved shape. The curved shape may allow the respirator 410 to be aligned with the face of the user. In some examples, the single housing 420 extends between a first housing end 446 and a second housing end 448 opposite to the first housing end 446. In some examples, the at least one housing 420 (i.e., the single housing 420) includes at least one strap 404 configured to be coupled to a head harness (e.g., the head harness 106 shown in FIG. 1) worn by the user. The term “single housing 420” is interchangeably referred to hereinafter as “the housing 420”.

The respirator 410 further includes at least one cover 430 movably to the at least one housing 420 (i.e., the single housing 420) and including a plurality of cover openings 432 (shown in FIG. 16B) therethrough. In the illustrated embodiment of FIGS. 16A and 16B, the at least one cover 430 further includes a first cover 442 movably coupled to the at least one housing 420 (i.e., the single housing 420). In some examples, the at least one cover 430 further includes a second cover 444 movably coupled to the at least one housing 420 (i.e., the single housing 420) and spaced apart from the first cover 442.

In some examples, the first cover 442 is substantially similar to the second cover 444. In some examples, each of the first cover 442 and the second cover 444 is substantially rectangular. In some examples, each of the first cover 442 and the second cover 444 incudes the plurality of cover openings 432 therethrough. In some examples, the single housing 420, the first cover 442, and the second cover 444 are integrally formed as a unitary part. In some examples, the single housing 420, the first cover 442, and the second cover 444 may be produced using additive manufacturing techniques from a rigid material.

In some examples, the single housing 420 further includes a first wall 452 (shown in FIG. 16B) facing each of the first cover 442 and the second cover 444. In some examples, the first wall 452 further faces the mask body 412. In some examples, the single housing 420 further includes a second wall 462 (shown in FIG. 16A) opposite to the first wall 452 and devoid of any openings. In some examples, the second wall 462 faces away from the mask body 412. In some examples, the first wall 452 and the second wall 462 are curved.

In some examples, the at least one cover 430 is pivotally coupled to the at least one housing 420 (i.e., the single housing 420). Specifically, each of the first cover 442 and the second cover 444 is pivotally coupled to the at least one housing 420 (i.e., the single housing 420). More specifically, each of the first cover 442 and the second cover 444 is pivotally coupled to the first wall 452 through a pivot connection 438 (shown in FIG. 16B). However, it should be understood that the first cover 442 and the second cover 444 may be coupled to the single housing 420 through any other suitable coupling mechanism. Further, the pivot connection 438 is similar to the pivot connection 238 (shown in FIGS. 11A-12).

In some examples, the at least one cover 430 (i.e., the first cover 442 and the second cover 444) is stationary relative to the at least one housing 420 (i.e., the single housing 420) in the coupled state S1. In some examples, each of the first cover 442 and the second cover 444 is further configured to be snap-fitted to the single housing 420. Specifically, in the coupled state S1, the at least one cover 430 (i.e., the first cover 442 and the second cover 444) is snap-fitted to the at least one housing 420 (i.e., the single housing 420).

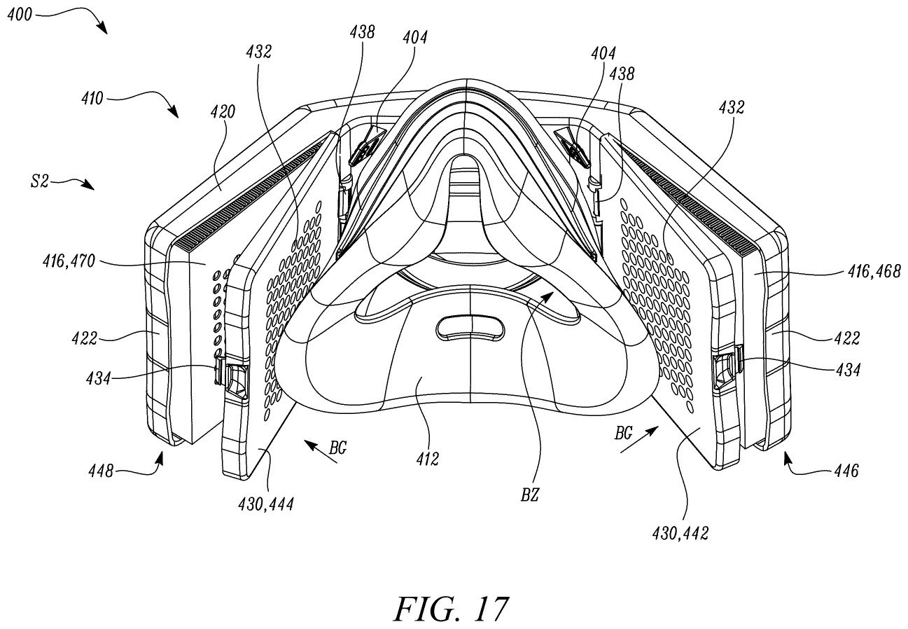

FIG. 17 is a schematic rear perspective view of the respiratory system 300 in the uncoupled state S2. In some examples, the at least one cover 430 (i.e., the first cover 442 and the second cover 444) is pivotable relative to the at least one housing 420 (i.e., the single housing 420) in the uncoupled state S2.

The respiratory system 400 further includes at least one filter component 416 removably received between the at least one housing 420 (i.e., the single housing 420) and the at least one cover 330. Specifically, the at least one housing 420 (i.e., the single housing 420) and the at least one cover 430 are configured to removably receive the at least one filter component 416 therebetween. In some examples, the at least one filter component 416 is P3R-P100 Prototype Particulate Filter Element available from 3M Company, St. Paul, Minn., USA.

In some examples, the first cover 442 and the at least one housing 420 (i.e., the single housing 420) are configured to removably receive a first filter component 468 therebetween. In some examples, the second cover 444 and the at least one housing 420 (i.e., the single housing 420) are configured to removably receive a second filter component 470 therebetween. The at least one filter component 416 therefore includes the first filter component 468 and the second filter component 470.

Each of the plurality of cover openings 432 is configured to allow the breathable gas BG to flow therethrough, such that the breathable gas BG passes through the at least one filter component 416 before entering the breathable zone BZ. In some examples, the breathable gas BG passes through each of the first filter component 468 and the second filter component 470 before entering the breathable zone BZ. In some examples, the breathable gas BG may enter the respirator 410 from a rear side of the respirator 410, i.e., the side that faces the user. Thus, the user may be protected from direct exposure of biohazards from the front side of the respirator 410, i.e., the side opposite to the rear side.

In some examples, the at least one cover 430 further includes one or more first features 434. Specifically, each of the first cover 442 and the second cover 444 includes the one or more first features 434. In some examples, the at least one housing 420 (i.e., the single housing 420) includes one or more second features 422 complementary to the one or more first features 434. In some examples, the one the more first features 434 are configured to form a snap-fit connection with the one or more second features 422.

In the illustrated embodiment of FIG. 17, the one or more first features 434 include an elastic tongue and the one or more second features 422 include a protrusion configured to engage with the elastic tongue in the coupled state S1 (shown in FIGS. 16A and 16B) to form the snap-fit connection. Thus, the snap-fit connection may allow the first cover 442 and the second cover 444 to be uncoupled from the single housing 420, thereby enabling replacement of the respective first filter component 468 and the second filter component 470, respectively.

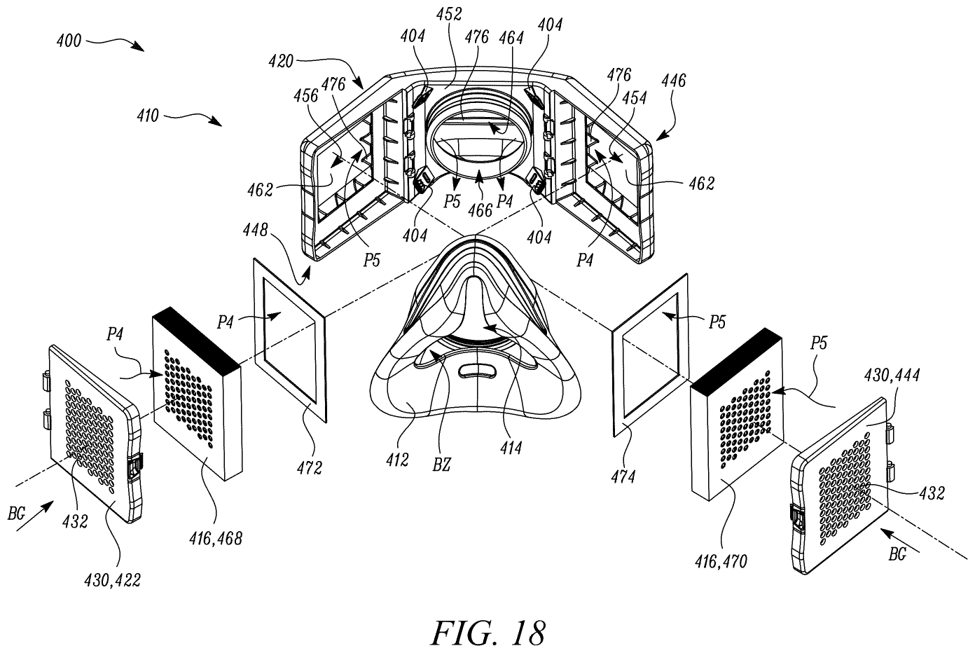

FIG. 18 is a schematic rear exploded perspective view of the respiratory system 400. In the illustrated embodiment of FIG. 18, the at least one strap 404 includes two pairs of straps 404 extending from the single housing 420. However, it should be understood that the single housing 420 may include any number of straps 404.

The at least one housing 420 (i.e., the single housing 420) is disposed in fluid communication with the breathable zone BZ of the mask body 412. In some examples, the single housing 420 is detachably coupled to the mask body 412. In some examples, the mask body 412 includes a mask opening 414 extending therethrough. In some examples, the single housing 420 is detachably coupled to the mask opening 414 of the mask body 412.

In some examples, the first wall 452 includes a first opening 454 extending therethrough and at least partially aligned with the first cover 442. In some examples, the first wall 452 further includes a second opening 456 extending therethrough and spaced apart from the first opening 454. In some examples, the first opening 454 is substantially similar to the second opening 456. In some examples, the first opening 454 and the second opening 456 are disposed in fluid communication with the breathable zone BZ. In some examples, the breathable gas BG passes through the first opening 454 and the second opening 456 before entering the breathable zone BZ.

In some examples, the respirator 410 further includes a first seal 472 disposed within the first opening 454 between the first filter component 468 and the single housing 420. In some examples, the respirator 410 further includes a second seal 474 disposed within the second opening 456 between the second filter component 470 and the single housing 420. In some examples, each of the first seal 472 and the second seal 474 may be made of a resilient polymeric material, such as rubber, silicone, or the like. The polymeric material may be solid or may be a foam (e.g., an open-cell foam or a closed-cell foam).

In some examples, each of the first seal 472 and the second seal 474 may minimize or eliminate any fluid leakage between the single housing 420 and the respective first filter component 468 and the second filter component 470. In other words, each of the first seal 472 and the second seal 474 may ensure that the breathable gas BG may only reach the breathable zone BZ of the mask body 412 by way of passing through the respective first filter component 468 and the second filter component 470.

In some examples, each of the first seal 472 and the second seal 474 may be permanently attached to the single housing 420, or it may be removable and replaceable if desired. Alternatively, each of the first seal 472 and the second seal 474 may be provided along with the respective first filter component 468 and the second filter component 470, such that each of the first seal 472 and the second seal 474 may be removed along with the respective first filter component 468 and the second filter component 470 when a new filter component is inserted.

In some examples, the first wall 452 and the second wall 462 at least partially define a housing chamber 464 therebetween. In some examples, the housing chamber 464 is disposed in fluid communication with each of the first opening 454 and the second opening 456. In some examples, the breathable gas BG is received within the housing chamber 464 through the first opening 454 and the second opening 456 as indicated by flow P4 and flow P5, respectively.

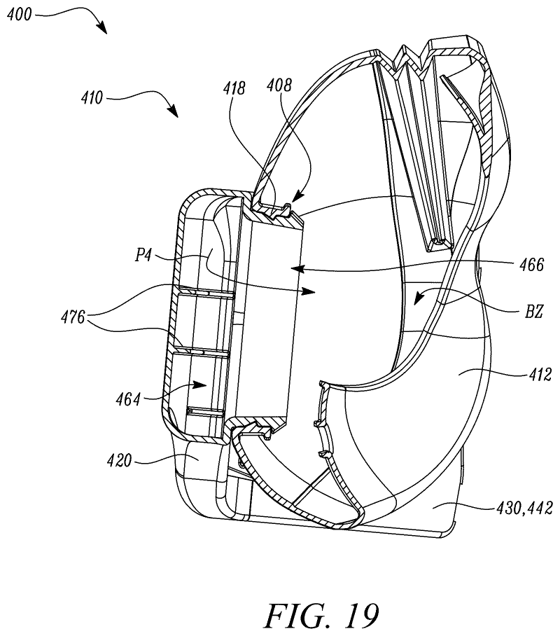

In some examples, the first wall 452 further includes a common opening 466 extending therethrough and disposed in fluid communication with the housing chamber 464. In some examples, the mask opening 414 is disposed in fluid communication with the common opening 466 of the first wall 452. In some examples, the single housing 420 further includes a plurality of protrusions 476 (also shown in FIG. 19) disposed within the housing chamber 464 and configured to direct the breathable gas BG from the first opening 454 and the second opening 456 towards the common opening 466.

In some examples, the breathable gas BG enters through the plurality of cover openings 432 of each of the first cover 442 and the second cover 444, passes through each of the first filter component 468 and the second filter component 470, enters the housing chamber 464, and then enters the breathable zone BZ through the common opening 466 and the mask opening 414 as indicated by the flow P4 and the flow P5, respectively.

FIG. 19 is a schematic sectional side view of the respiratory system 400. In some examples, at least one of the mask body 412 and the at least one housing 420 (i.e., the single housing 420) includes one or more annular barbs 418 configured to form an annular barbed seal 408 between the mask body 412 and the at least one housing 420 (i.e., the single housing 420). In the illustrated embodiment of FIG. 19, the mask body 412 includes the one or more annular barbs 418 that engages with corresponding features on the single housing 420 to form the annular barbed seal 408. In some examples, the annular barbed seal 408 may allow a fluid tight connection between the single housing 420 and the mask body 412.

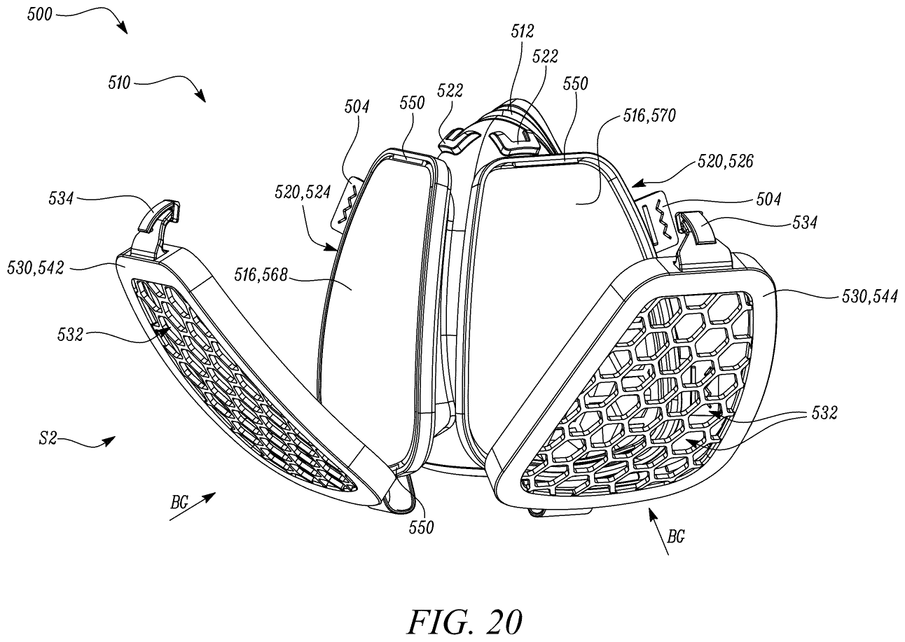

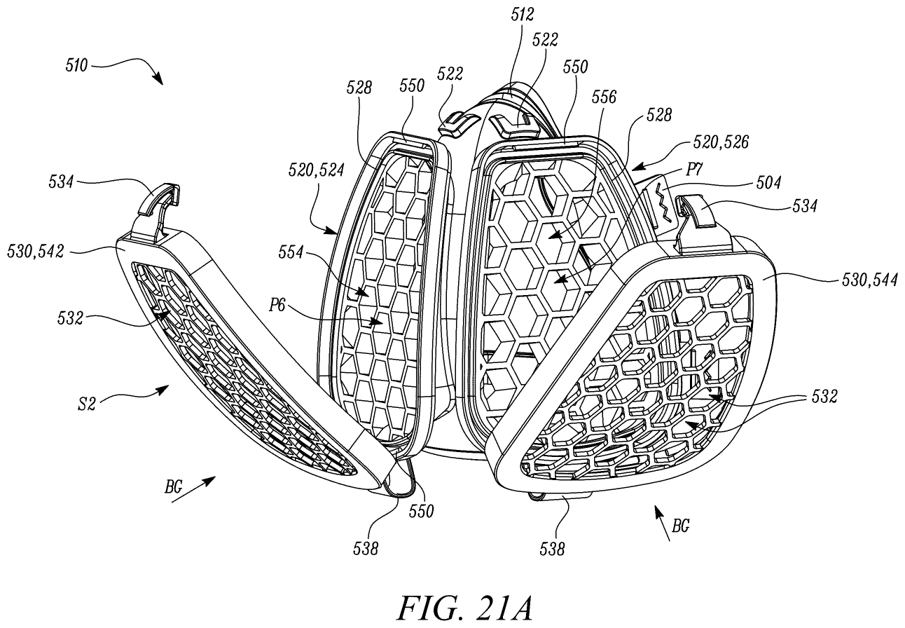

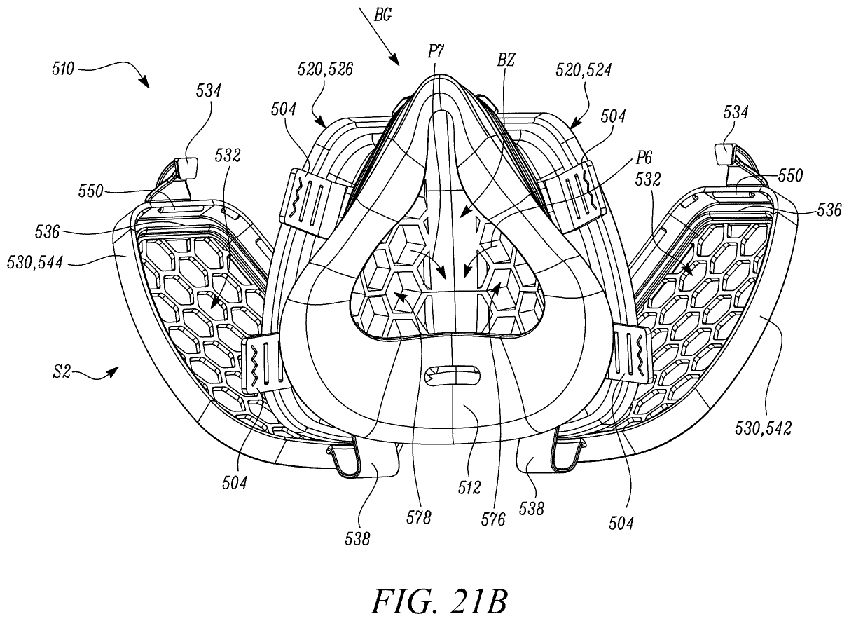

FIGS. 20 is schematic front perspective view of a respiratory system 500. The respiratory system 500 may be functionally similar to the respiratory system 300 (shown in FIGS. 13A-15), and equivalent reference numbers are used to indicate similar or identical components. The respiratory system 500 includes a respirator 510. The respirator 510 includes a mask body 512 defining the breathable zone BZ (shown in FIG. 21B) for a user (e.g., the user 102 shown in FIG. 1).

In some examples, the mask body 512 includes at least one strap 504 configured to be coupled to a head harness (e.g., the head harness 106 shown in FIG. 1) worn by the user. In the illustrated embodiment of FIG. 20, the at least one strap 504 includes a pair of straps 504 extending from the mask body 512. However, it should be understood that the mask body 512 may include any number of straps 504.

The respirator 510 further includes at least one housing 520 directly or indirectly coupled to the mask body 512. In the illustrated embodiment of FIG. 19, the at least one housing 520 is directly coupled to the mask body 512. The at least one housing 520 is disposed in fluid communication with the breathable zone BZ (shown in FIG. 21B) of the mask body 512. Further, the at least one housing 520 includes a first housing 524 and a second housing 526 separate from the first housing 524. The respirator 510 further includes at least one cover 530 movably coupled to the at least one housing 520 and including a plurality of cover openings 532 therethrough.

In the illustrated embodiment of FIG. 20, the at least one cover 530 further includes a first cover 542 movably coupled to the at least one housing 520. Specifically, the first cover 542 is movably coupled to the first housing 524. In some examples, the at least one cover 530 further includes a second cover 544 movably coupled to the at least one housing 520 and spaced apart from the first cover 542. Specifically, the second cover 544 is movably coupled to the second housing 526. In some examples, the first cover 542 is substantially similar to the second cover 544. In some examples, each of the first cover 542 and the second cover 544 is curved. In some examples, each of the first cover 542 and the second cover 544 incudes the plurality of cover openings 532 therethrough.

In some examples, the at least one cover 530 is pivotally coupled to the at least one housing 520. Specifically, each of the first cover 542 and the second cover 544 is pivotally coupled to the at least one housing 520. Specifically, the first cover 542 is pivotally coupled to the first housing 524 and the second cover 544 is pivotally coupled to the second housing 526. In some examples, the at least one cover 530 (i.e., the first cover 542 and the second cover 544) is pivotable relative to the at least one housing 520 in the uncoupled state S2.

In some examples, the at least one housing 520 (i.e., the first housing 524 and the second housing 526), the first cover 542, and the second cover 544 are integrally formed as a unitary part. In some examples, the at least one housing 520 (i.e., the first housing 524 and the second housing 526), the first cover 542, and the second cover 544 may be produced using additive manufacturing techniques from a rigid material.

The respiratory system 500 further includes at least one filter component 516 removably received between the at least one housing 520 and the at least one cover 530. Specifically, the at least one housing 520 and the at least one cover 530 are configured to removably receive at least one filter component 516 therebetween. Each of the plurality of cover openings 532 is configured to allow the breathable gas BG to flow therethrough, such that the breathable gas BG passes through the at least one filter component 516 before entering the breathable zone BZ (shown in FIG. 21B). In some examples, the at least one filter component 516 is 5N11 N95 Particulate Filter available from 3M Company, St. Paul, Minn., USA.

In some examples, the first cover 542 and the at least one housing 420 are configured to removably receive a first filter component 568 therebetween. More specifically, the first housing 524 and the first cover 542 removably receive the first filter component 568 therebetween. In some examples, the second cover 544 and the at least one housing 520 are configured to removably receive a second filter component 570 therebetween. Specifically, the second housing 526 and the second cover 544 removably receive the second filter component 570 therebetween. In some examples, the breathable gas BG passes through each of the first filter component 568 and the second filter component 570 before entering the breathable zone BZ (shown in FIG. 21B). The at least one filter component 516 therefore includes the first filter component 568 and the second filter component 570.

In some examples, the at least one housing 520 (i.e., the first housing 524 and the second housing 526) further includes at least one ledge 550 configured to removably secure the at least one filter component 516 to the at least one housing 520. Specifically, the at least one ledge 550 is configured to removably secure the first filter component 568 to the first housing 524 and the second filter component 570 to the second housing 526. In the illustrated embodiment of FIG. 20, the at least one ledge 550 includes a plurality of ledges 550. In some examples, each of the plurality of ledges 550 is in the form of a protrusion that secures the first filter component 568 and the second filter component 570 to the first housing 524 and the second housing 526, respectively.

In some examples, the at least one cover 530 (i.e., the first cover 542 and the second cover 544) is stationary relative to the at least one housing 520 (i.e., the first housing 524 and the second housing 526) in a coupled state (not shown). In some examples, the first cover 542 is further configured to be snap-fitted to the first housing 524 and the second cover 544 is further configured to be snap-fitted to the second housing 526. Specifically, in the coupled state, the at least one cover 530 is snap-fitted to the at least one housing 520, i.e., the first cover 542 is snap-fitted to the first housing 524 and the second cover 544 is snap-fitted to the second housing 526.

In some examples, the at least one cover 530 further includes one or more first features 534. Specifically, each of the first cover 542 and the second cover 544 includes the one or more first features 534. In some examples, the mask body 512 includes one or more second features 522 complementary to the one or more first features 534. In some examples, the one the more first features 534 are configured to form a snap-fit connection with the one or more second features 522. In the illustrated embodiment of FIG. 20, the one or more first features 534 include an elastic tongue and the one or more second features 522 include a groove configured to engage with the elastic tongue in the coupled state to form the snap-fit connection. Thus, the snap-fit connection may allow the first cover 542 and the second cover 544 to be uncoupled from the first housing 524 and the second housing 526, thereby enabling replacement of the first filter component 568 and the second filter component 570, respectively.

FIGS. 21A and 21B are schematic front and rear perspective views, respectively, of the respirator 510. Referring now to FIGS. 21A and 21B, in some examples, the respirator 510 further includes at least one living hinge 538 pivotally coupling the at least one cover 530 to the at least one housing 520. Specifically, the at least one living hinge 538 pivotally couples the first cover 542 to the first housing 524 and the second cover 544 to the second housing 526. Alternatively, the first cover 542 and the second cover 544 may be pivotally coupled to the respective first housing 524 and the second housing 526 through a pivot connection (e.g., the pivot connection 238 shown in FIGS. 11A-12). However, it should be understood that the first cover 542 and the second cover 544 may be coupled to the respective first housing 524 and the second housing 526 through any other suitable coupling mechanism.

In some examples, the at least one cover 530 further includes a continuous cover knife edge seal 536 (shown in FIG. 21B) configured to engage with the at least one filter component 516 (shown in FIG. 20). Specifically, the first cover 542 includes the continuous cover knife edge seal 536 configured to engage with the first filter component 568 (shown in FIG. 20) and the second cover 544 includes the continuous cover knife edge seal 536 configured to engage with the second filter component 570 (shown in FIG. 20).

In some examples, the at least one housing 520 includes a continuous housing knife edge seal 528 (shown in FIG. 21A) spaced apart from the continuous cover knife edge seal 536 and configured to engage with the at least one filter component 516 (shown in FIG. 20). Specifically, the first housing 524 includes the continuous housing knife edge seal 528 configured to engage with the first filter component 568 (shown in FIG. 20) and the second housing 526 includes the continuous housing knife edge seal 528 configured to engage with the second filter component 570 (shown in FIG. 20). In some examples, the continuous cover knife edge seal 536 and the continuous housing knife edge seal 528 may hold the first filter component 568 and the second filter component 570 in place between the first housing 524 and the second housing 526, respectively.

In some examples, the mask body 512 includes a first mask opening 576 (shown in FIG. 21B) extending therethrough and a second mask opening 578 (shown in FIG. 21B) extending therethrough. In some examples, each of the first mask opening 576 (shown in FIG. 21B) and the second mask opening 578 (shown in FIG. 21B) is disposed in fluid communication with the breathable zone BZ.

In some examples, the first housing 524 includes a first housing opening 554 (shown in FIG. 21A) extending therethrough and disposed in fluid communication with the first mask opening 576. In some examples, the second housing 526 includes a second housing opening 556 (shown in FIG. 21A) extending therethrough and disposed in fluid communication with the second mask opening 578.

In some examples, the breathable gas BG flows through the plurality of cover openings 532 of the first cover 542, passes through the first filter component 568 (shown in FIG. 20), and then enters the breathable zone BZ through the first housing opening 554 and the first mask opening 576 as indicated by flow P6. In some examples, the breathable gas BG further flows through the plurality of cover openings 532 of the second cover 544, passes through the second filter component 570 (shown in FIG. 20), and then enters the breathable zone BZ through the second housing opening 556 and the second mask opening 578 as indicated by flow P7.

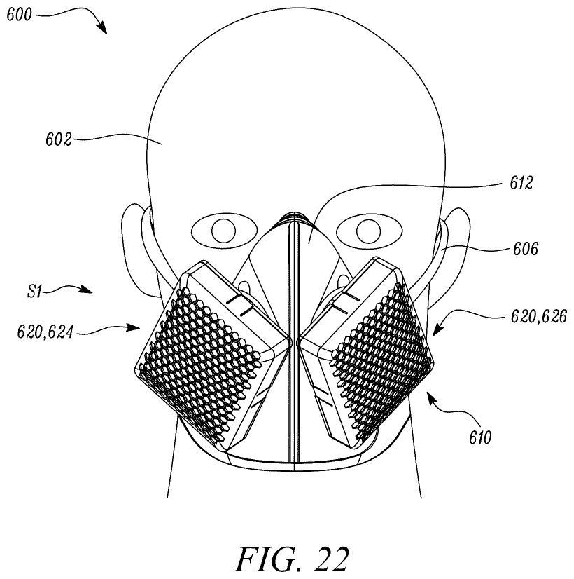

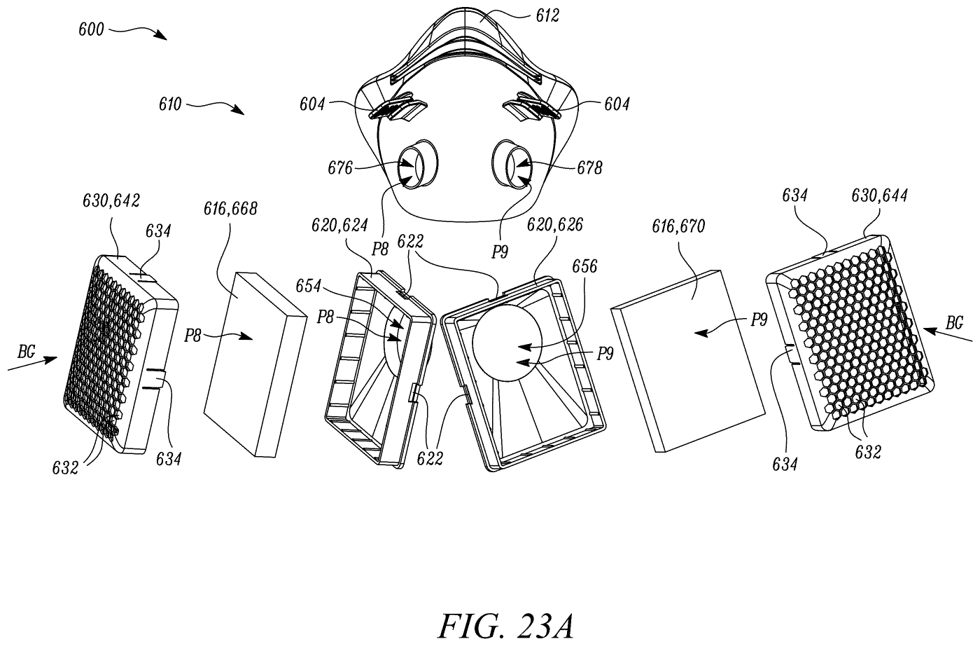

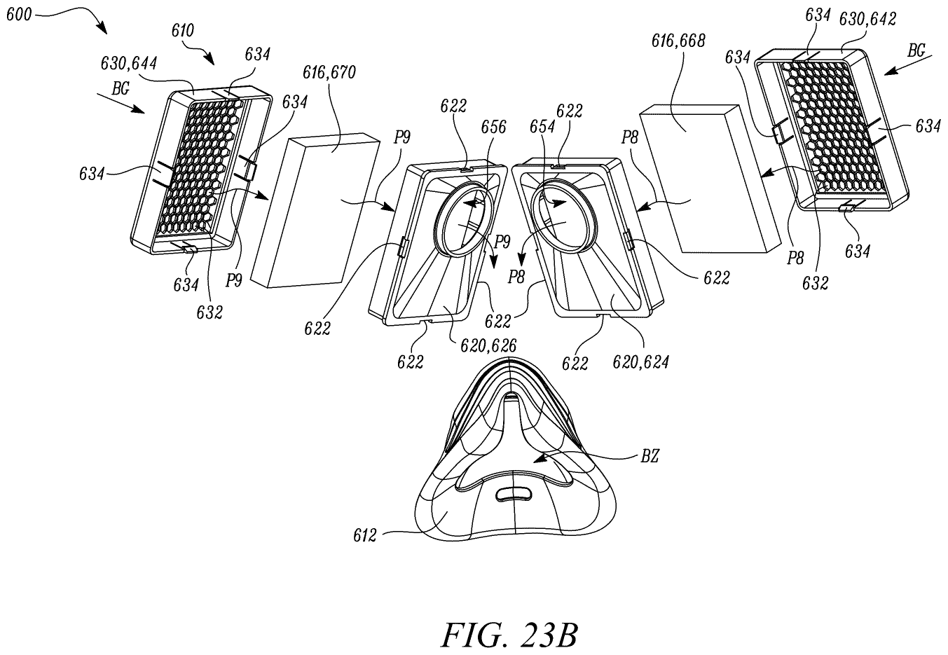

FIG. 22 is schematic view of a respiratory system 600. The respiratory system 600 may be functionally similar to the respiratory system 500 (shown in FIGS. 20-21B), and equivalent reference numbers are used to indicate similar or identical components. The respiratory system 600 includes a respirator 610. The respirator 610 includes a mask body 612 defining the breathable zone BZ (shown in FIG. 23B) for a user 602.

The respirator 610 further includes at least one housing 620 directly or indirectly coupled to the mask body 612. In the illustrated embodiment of FIG. 22, the at least one housing 620 is directly coupled to the mask body 612. Further, the at least one housing 620 includes a first housing 624 and a second housing 626 separate from the first housing 624. The at least one housing 620 (i.e., the first housing 624 and the second housing 626) is disposed in fluid communication with the breathable zone BZ of the mask body 612.

FIGS. 23A and 23B are schematic front and rear exploded perspective views, respectively, of the respiratory system 600. In some examples, the mask body 612 includes at least one strap 604 configured to be coupled to a head harness 606 worn by the user 602. In the illustrated embodiment of FIG. 23A, the at least one strap 604 includes a pair of straps 604 extending from the mask body 612. However, it should be understood that the mask body 612 may include any number of straps 604.

The respirator 610 further includes at least one cover 630 removably coupled to the at least one housing 620 and including a plurality of cover openings 632 therethrough. Each of the plurality of cover openings 632 is configured to allow the breathable gas BG to flow therethrough. In some examples, the at least one cover 630 is removably coupled to the at least one housing 620.

In the illustrated embodiment of FIGS. 23A and 23B, the at least one cover 630 further includes a first cover 642 removably coupled to the at least one housing 620. Specifically, the first cover 642 is removably coupled to the first housing 624. In some examples, the at least one cover 630 further includes a second cover 644 removably coupled to the at least one housing 620 and spaced apart from the first cover 642. Specifically, the second cover 644 is removably coupled to the second housing 626. In some examples, each of the first cover 642 and the second cover 644 incudes the plurality of cover openings 632 therethrough.

In some examples, the first cover 642 is substantially similar to the second cover 644. In some examples, each of the first cover 642 and the second cover 644 is substantially rectangular. In some examples, the at least one housing 620 (i.e., the first housing 624 and the second housing 626), the first cover 642, and the second cover 644 may be produced using additive manufacturing techniques from a rigid material.

In some examples, the at least one cover 630 (i.e., the first cover 642 and the second cover 644) is stationary relative to the at least one housing 620 (i.e., the first housing 624 and the second housing 626) in the coupled state S1 (shown in FIG. 22). In some examples, the first cover 642 is further configured to be snap-fitted to the first housing 624 and the second cover 644 is further configured to be snap-fitted to the second housing 626. In some examples, in the coupled state S1 (shown in FIG. 22), the at least one cover 630 is snap-fitted to the at least one housing 620, i.e., the first cover 642 is snap-fitted to the first housing 624 and the second cover 644 is snap-fitted to the second housing 626.

The respiratory system 600 further includes at least one filter component 616 removably received between the at least one housing 620 and the at least one cover 630. Specifically, the at least one housing 620 and the at least one cover 630 are configured to removably receive the at least one filter component 616 therebetween. In some examples, the at least one filter component 616 is P3R-P100 Prototype Particulate Filter Element available from 3M Company, St. Paul, Minn., USA.

In some examples, the first cover 642 and the at least one housing 620 are configured to removably receive a first filter component 668 therebetween. Specifically, the first housing 624 and the first cover 642 removably receive the first filter component 668 therebetween. In some examples, the second cover 644 and the at least one housing 620 are configured to removably receive a second filter component 670 therebetween. Specifically, the second housing 626 and the second cover 644 removably receive the second filter component 670 therebetween. The at least one filter component 616 therefore includes the first filter component 668 and the second filter component 670.

In some examples, the respirator 610 may further include one or more seals (not shown) disposed within the first housing 624 between the first filter component 668 and the first housing 624. Similarly, the respirator 610 may further include the one or more seals disposed within the second housing 626 between the second filter component 670 and the second housing 626. In some examples, the one or more seals may be made of a resilient polymeric material, such as rubber, silicone, or the like. The polymeric material may be solid or may be a foam (e.g., an open-cell foam or a closed-cell foam). In some examples, the one or more seals may prevent fluid leakage between the first housing 624 and the first filter component 668, and between the second housing 626 and the second filter component 670.

In some examples, the at least one cover 630 further includes one or more first features 634. Specifically, each of the first cover 642 and the second cover 644 includes the one or more first features 634. In some examples, the at least one housing 620 (i.e., the first housing 624 and the second housing 626) includes one or more second features 622 complementary to the one or more first features 634. In some examples, the one the more first features 634 are configured to form a snap-fit connection with the one or more second features 622.

In the illustrated embodiment of FIGS. 23A and 23B, the one or more first features 634 include an elastic tongue and the one or more second features 622 include a groove configured to engage with the elastic tongue in the coupled state S1 (shown in FIG. 22) to form the snap-fit connection. Thus, the snap-fit connection may allow the first cover 642 and the second cover 644 to be removed from the first housing 624 and the second housing 626, thereby enabling replacement of the first filter component 568 and the second filter component 570, respectively.

In some examples, each of the plurality of cover openings 632 is configured to allow the breathable gas BG to flow therethrough, such that the breathable gas BG passes through the at least one filter component 616 before entering the breathable zone BZ (shown in FIG. 23B). In some examples, the breathable gas BG passes through each of the first filter component 668 and the second filter component 670 before entering the breathable zone BZ.

In some examples, the mask body 612 further includes a first mask opening 676 extending therethrough and a second mask opening 678 extending therethrough. In some examples, each of the first mask opening 676 and the second mask opening 678 is disposed in fluid communication with the breathable zone BZ. In some examples, the first housing 624 includes a first housing opening 654 extending therethrough and disposed in fluid communication with the first mask opening 676. In some examples, the second housing 626 includes a second housing opening 656 extending therethrough and disposed in fluid communication with the second mask opening 678.

In some examples, the breathable gas BG flows through the plurality of cover openings 632 of the first cover 642, passes through the first filter component 668, and then enters the breathable zone BZ through the first housing opening 654 and the first mask opening 676 as indicated by flow P8. In some examples, the breathable gas BG further flows through the plurality of cover openings 632 of the second cover 644, passes through the second filter component 670, and then enters the breathable zone BZ through the second housing opening 656 and the second mask opening 678 as indicated by flow P9.

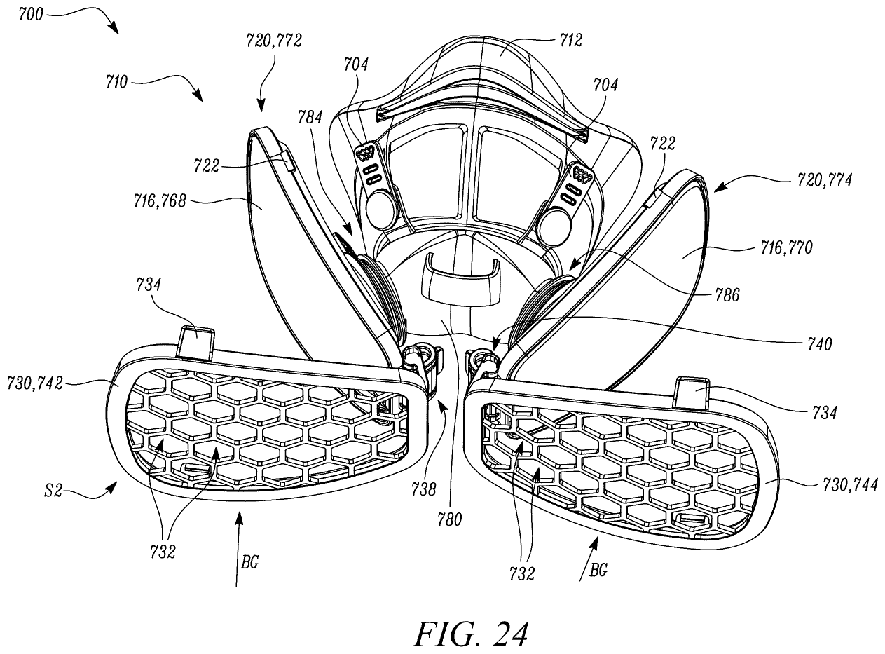

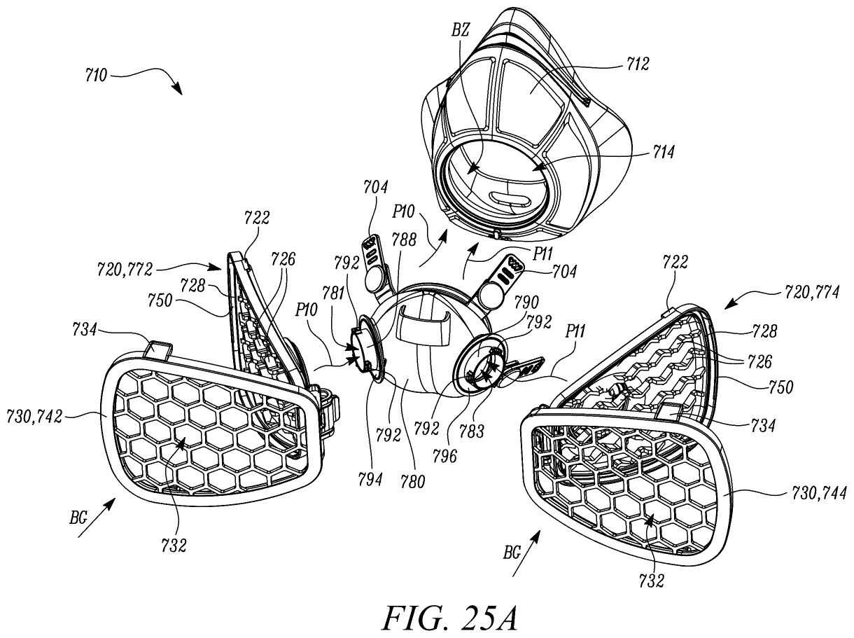

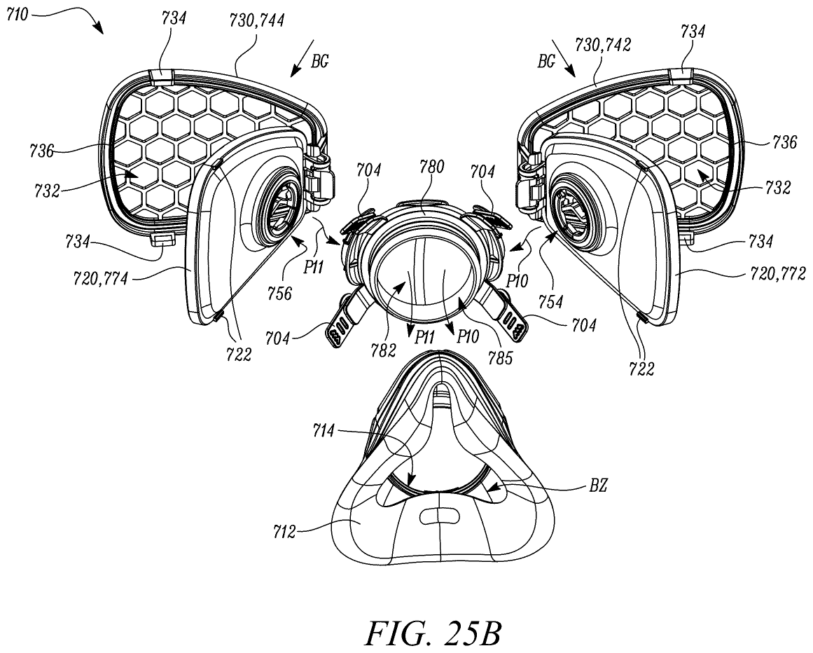

FIG. 24 is a schematic perspective view of a respiratory system 700. The respiratory system 700 may be functionally similar to the respiratory system 100 (shown in FIGS. 1-6B), and equivalent reference numbers are used to indicate similar or identical components. The respiratory system 700 includes a respirator 710. The respirator 710 includes a mask body 712 defining the breathable zone BZ (shown in FIGS. 25A and 25B) for a user (e.g., the user 102 shown in FIG. 1).

The respirator 710 further includes at least one housing 720 directly or indirectly coupled to the mask body 712. In the illustrated embodiment of FIG. 24, the at least one housing 720 is indirectly coupled to the mask body 712. The at least one housing 720 is disposed in fluid communication with the breathable zone BZ (shown in FIGS. 25A and 25B) of the mask body 712. In some examples, the at least one housing 720 includes a first housing 772 and a second housing 774 separate from the first housing 772. Each of the first housing 772 and the second housing 774 is disposed in fluid communication with the breathable zone BZ (shown in FIGS. 25A and 25B) of the mask body 712.

In some examples, the respirator 710 further includes a hub 780 detachably coupled to each of the mask body 712 and the at least one housing 720. In some examples, each of the first housing 772 and the second housing 774 is detachably coupled to the hub 780, such that each of the first housing 772 and the second housing 774 is indirectly coupled to the mask body 712 via the hub 780. In some examples, the respirator 710 further includes at least one strap 704 extending from the hub 780 and configured to be coupled to a head harness (e.g., the head harness 106 shown in FIG. 1) worn by the user. In the illustrated embodiment of FIG. 24, the at least one strap 704 includes a plurality of straps 704 extending from the hub 780. However, it should be understood that the hub 780 may include any number of straps 704.

The respirator 710 further includes at least one cover 730 movably or removably coupled to the at least one housing 720 and including a plurality of cover openings 732 therethrough. In the illustrated embodiment of FIG. 24, the at least one cover 730 further includes a first cover 742 movably coupled to the at least one housing 720. Specifically, the first cover 742 is movably coupled to the first housing 772. In some examples, the at least one cover 730 further includes a second cover 744 movably coupled to the at least one housing 720 and spaced apart from the first cover 742. Specifically, the second cover 744 is movably coupled to the second housing 774.

In some examples, the at least one cover 730 is pivotally coupled to the at least one housing 720. Specifically, the first cover 742 is pivotally coupled to the at least one housing 720. More specifically, the first cover 742 is pivotally coupled to the first housing 772 via a first pivot connection 738. In some examples, the second cover 744 is pivotally coupled to the at least one housing 720. Specifically, the second cover 744 is pivotally coupled to the second housing 774 via a second pivot connection 740. The first pivot connection 738 and the second pivot connection 740 are similar to the pivot connection 238 (shown in FIGS. 11A-12). However, it should be understood that the first cover 742 and the second cover 744 may be coupled to the respective first housing 772 and the second housing 774 through any other suitable coupling mechanism.

In some examples, the at least one cover 730 is pivotable relative to the at least one housing 720 in the uncoupled state S2. Specifically, in the uncoupled state S2, the first cover 742 is pivotable relative to the first housing 772 and the second cover 744 is pivotable relative to the second housing 774. In some examples, the at least one cover 730 (i.e., the first cover 742 and the second cover 744) is stationary relative to the at least one housing 720 (i.e., the first housing 772 and the second housing 626) in a coupled state (not shown). In some examples, the first cover 742 is further configured to be snap-fitted to the first housing 772 and the second cover 744 is further configured to be snap-fitted to the second housing 774. Specifically, in the coupled state, the at least one cover 730 is snap-fitted to the at least one housing 720, i.e., the first cover 742 is snap-fitted to the first housing 772 and the second cover 744 is snap-fitted to the second housing 774.

In some examples, the first cover 742 is substantially similar to the second cover 744. In some examples, the at least one housing 720 (i.e., the first housing 772 and the second housing 774), the first cover 742, and the second cover 744 may be produced using additive manufacturing techniques from a rigid material. In some examples, each of the first cover 742 and the second cover 744 incudes the plurality of cover openings 732 therethrough. Each of the plurality of cover openings 732 is configured to allow the breathable gas BG to flow therethrough.

The respiratory system 700 further includes at least one filter component 716 removably received between the at least one housing 720 and the at least one cover 730. Specifically, the at least one housing 720 and the at least one cover 730 are configured to removably receive the at least one filter component 716 therebetween. In some examples, the at least one filter component 716 is 5N11 N95 Particulate Filter available from 3M Company, St. Paul, Minn., USA. In some examples, the first cover 742 and the at least one housing 720 are configured to removably receive a first filter component 768 therebetween. Additionally, the first housing 772 and the first cover 742 removably receive the first filter component 768 therebetween. In some examples, the second cover 744 and the at least one housing 720 are configured to removably receive a second filter component 770 therebetween. Specifically, the second housing 774 and the second cover 744 removably receive the second filter component 770 therebetween. The at least one filter component 716 therefore includes the first filter component 768 and the second filter component 770.

Each of the plurality of cover openings 732 is configured to allow the breathable gas BG to flow therethrough, such that the breathable gas BG passes through the at least one filter component 716 before entering the breathable zone BZ (shown in FIGS. 25A and 25B). In some examples, the breathable gas BG passes through each of the first filter component 768 and the second filter component 770 before entering the breathable zone BZ.

In some examples, the at least one cover 730 further includes one or more first features 734. Specifically, each of the first cover 742 and the second cover 744 includes the one or more first features 734. In some examples, the at least one housing 720 (i.e., the first housing 772 and the second housing 774) includes one or more second features 722 complementary to the one or more first features 734. In some examples, the one the more first features 734 are configured to form a snap-fit connection with the one or more second features 722.

In the illustrated embodiment of FIG. 24, the one or more first features 734 include an elastic tongue and the one or more second features 722 include a protrusion configured to engage with the elastic tongue in the coupled state to form the snap-fit connection. Thus, the snap-fit connection may allow the first cover 742 and the second cover 744 to be uncoupled from the first housing 772 and the second housing 774, thereby enabling replacement of the first filter component 768 and the second filter component 770, respectively.

FIGS. 25A and 25B are schematic front and rear exploded perspective views of the respirator 710, respectively. Referring now to FIGS. 25A and 25B, in some examples, the first housing 772 is detachably coupled to the hub 780 via a first bayonet coupling 784 (shown in FIG. 24). In some examples, the second housing 774 is detachably coupled to the hub 780 via a second bayonet coupling 786 (shown in FIG. 24). However, it should be understood that the first housing 772 and the second housing 774 may be detachably coupled to the hub 780 via any suitable coupling mechanism.

In some examples, the hub 780 includes a first cylindrical portion 788 configured to form the first bayonet coupling 784 with the first housing 772. In some examples, the hub 780 further includes a second cylindrical portion 790 configured to form the second bayonet coupling 786 with the second housing 774. In some examples, each of the first cylindrical portion 788 and the second cylindrical portion 790 includes one or more projections 792 configured to engage with the first housing 772 and the second housing 774 to form the first bayonet coupling 784 and the second bayonet coupling 786, respectively.

In some examples, the respirator 710 further includes a first annular seal 794 disposed around the first cylindrical portion 788 and disposed adjacent to the first bayonet coupling 784 (shown in FIG. 24). In some examples, the respirator 710 further includes a second annular seal 796 disposed around the second cylindrical portion 790 and disposed adjacent to the second bayonet coupling 786 (shown in FIG. 24). In some examples, the first and second annular seals 794, 796 may prevent fluid leakage between the hub 780 and the first housing 772 and second housing 774, respectively. In some examples, the first annular seal 794 and the second annular seal 796 may be made from silicone foam rubber.

In some examples, the at least one housing 720 further includes a plurality of ribs 726 configured to engage with the at least one filter component 716 (shown in FIG. 24). Specifically, the first housing 772 includes the plurality of ribs 726 configured to engage with the first filter component 768 (shown in FIG. 24) and the second housing 774 includes the plurality of ribs 726 configured to engage with the second filter component 770 (shown in FIG. 24). The plurality of ribs 726 may have a geometrical shape that enhances flow of the breathable gas BG through the first housing 772 and the second housing 774.

In some examples, the at least one housing 720 further includes at least one ledge 750 configured to removably secure the at least one filter component 716 (shown in FIG. 24) to the at least one housing 720. In the illustrated embodiment of FIGS. 25A and 25B, the at least one ledge 750 includes a plurality of ledges 750. Specifically, each of the plurality of ledges 750 is in the form of a protrusion that secures the first filter component 768 and the second filter component 770 to the first housing 772 and the second housing 774, respectively.

In some examples, the at least one cover 730 further includes a continuous cover knife edge seal 736 (shown in FIG. 25B) configured to engage with the at least one filter component 716. Specifically, the first cover 742 includes the continuous cover knife edge seal 736 configured to engage with the first filter component 768 and the second cover 744 also includes the continuous cover knife edge seal 736 configured to engage with the second filter component 770.

In some examples, the at least one housing 720 further includes a continuous housing knife edge seal 728 (shown in FIG. 25A) spaced apart from the continuous cover knife edge seal 736 and configured to engage with the at least one filter component 716. Specifically, the first housing 772 includes the continuous housing knife edge seal 728 configured to engage with the first filter component 768 and the second housing 774 includes the continuous housing knife edge seal 728 configured to engage with the second filter component 770.

In some examples, the mask body 712 includes a mask opening 714 (shown in FIG. 25B) extending therethrough and disposed in fluid communication with the breathable zone BZ. In some examples, the hub 780 further includes a hub chamber 782 (shown in FIG. 25B) disposed in fluid communication with the mask opening 714, a first hub opening 781 (shown in FIG. 25A) extending therethrough and disposed in fluid communication with the hub chamber 782, and a second hub opening 783 (shown in FIG. 25A) extending therethrough and disposed in fluid communication with the hub chamber 782. In some examples, the hub 780 further includes a common opening 785 (shown in FIG. 25B) fluidly communicating the hub chamber 782 with the mask opening 714.

In some examples, the first housing 772 further includes a first housing opening 754 (shown in FIG. 25B) extending therethrough and disposed in fluid communication with the first hub opening 781. In some examples, the second housing 774 further includes a second housing opening 756 (shown in FIG. 25B) extending therethrough and disposed in fluid communication with the second hub opening 783.

In some examples, the breathable gas BG flows through the plurality of cover openings 732 of the first cover 742, passes through the first filter component 768 (shown in FIG. 24), and then enters the breathable zone BZ through the first housing opening 754, the first hub opening 781, the hub chamber 782, the common opening 785, and the mask opening 714 as indicated by flow P10. Further, in some examples, the breathable gas BG flows through the plurality of cover openings 732 of the second cover 744, passes through the second filter component 770 (shown in FIG. 24), and then enters the breathable zone BZ through the second housing opening 756, the second hub opening 783, the hub chamber 782, the common opening 785, and the mask opening 714 as indicated by flow P11.

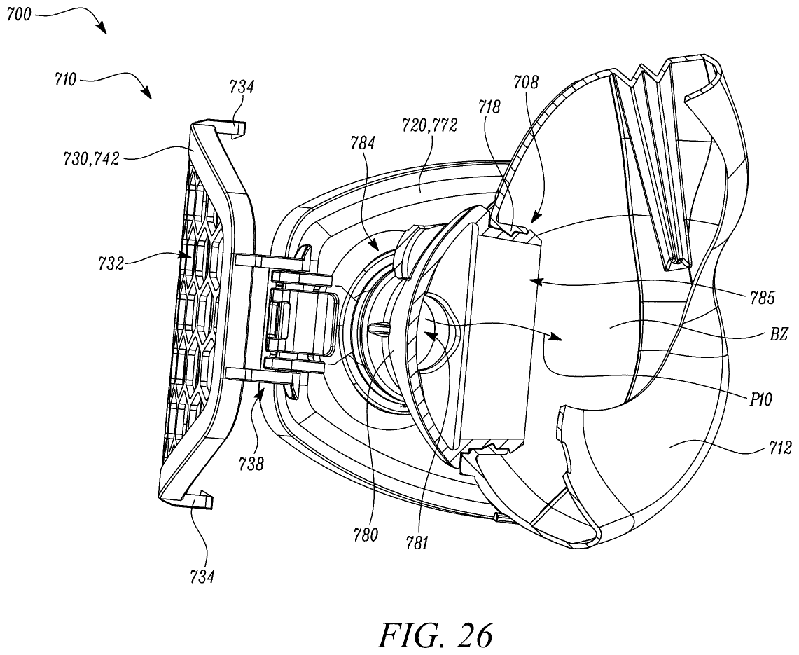

FIG. 26 is a schematic sectional side view of the respiratory system 700. In some examples, at least one of the mask body 712 and the hub 780 includes one or more annular barbs 718 configured to form an annular barbed seal 708 between the mask body 712 and the hub 780. In the illustrated embodiment of FIG. 26, the mask body 712 includes the one or more annular barbs 718 that engages with corresponding features on the hub 780 to form the annular barbed seal 708. In some examples, the annular barbed seal 708 may allow a fluid tight connection between the hub 780 and the mask body 712.

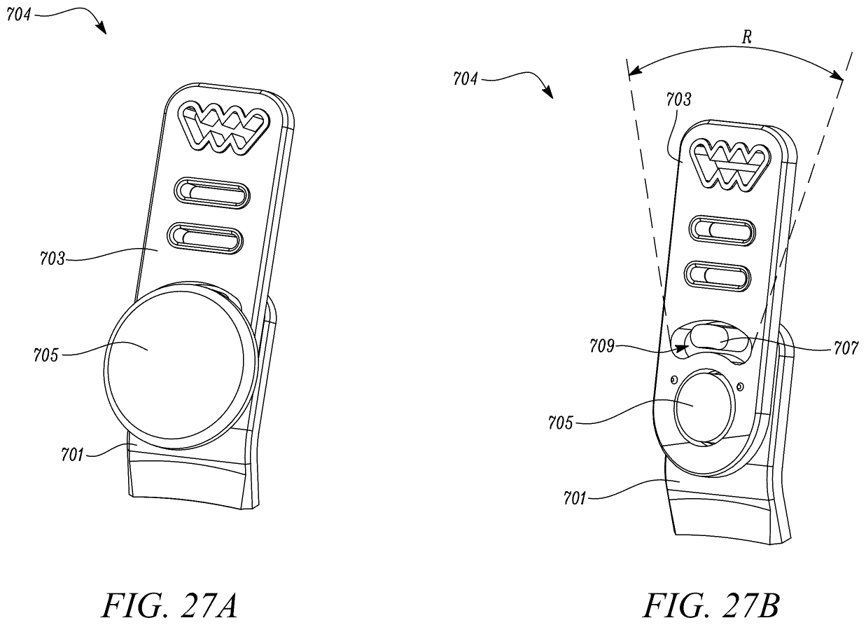

FIG. 27A is a schematic perspective view of the at least one strap 704. In some examples, the at least one strap 704 includes a first strap portion 701 extending from the hub 780 (shown in FIGS. 24-25B). In some examples, the at least one strap 704 further includes a second strap portion 703 rotatably coupled to the first strap portion 701 via a pin 705.

FIG. 27B is schematic perspective view of the at least one strap 704 with some components not shown. Specifically, a head of the pin 705 is not shown in FIG. 27B. Referring now to FIGS. 27A and 27B, in some examples, the first strap portion 701 includes a stop projection 707. In some examples, the second strap portion 703 includes a slot 709 extending therethrough and at least partially receiving the stop projection 707 therein. In some examples, the stop projection 707 has a cross-sectional area less than an area of the slot 709. In some examples, the stop projection 707 is configured to limit a range of rotation R of the second strap portion 703 relative to the first strap portion 701. In other words, the slot 709 may allow constrained movement of the stop projection 707, thereby restricting the range of rotation R of the second strap portion 703 relative to the first strap portion 701.

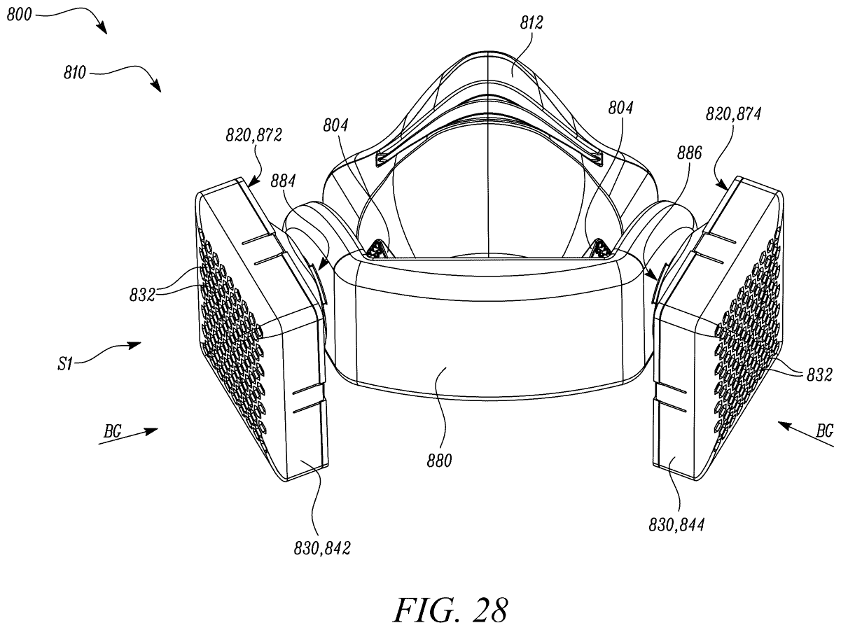

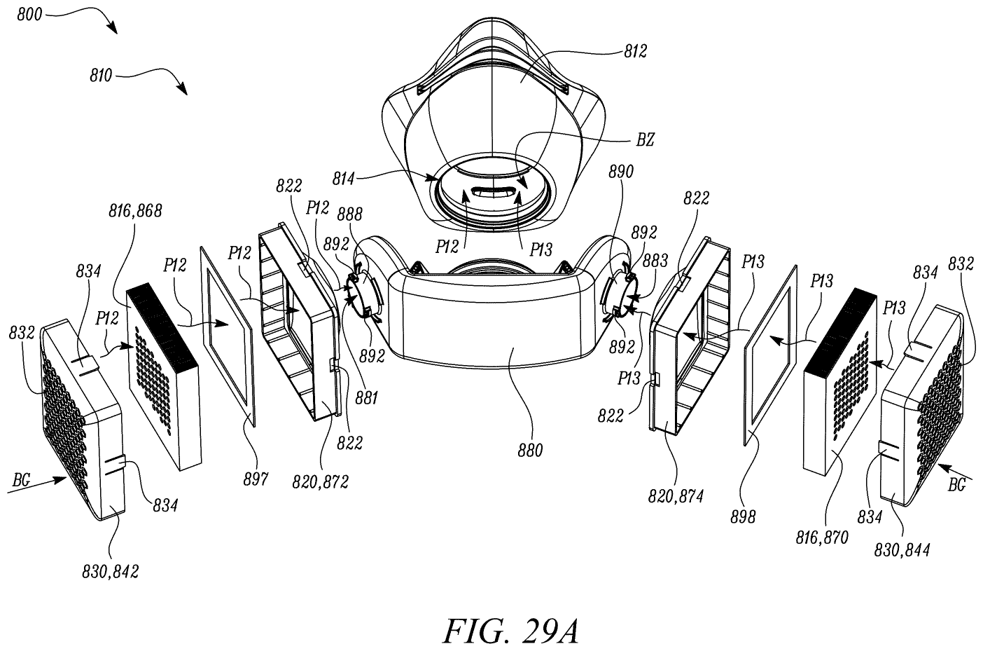

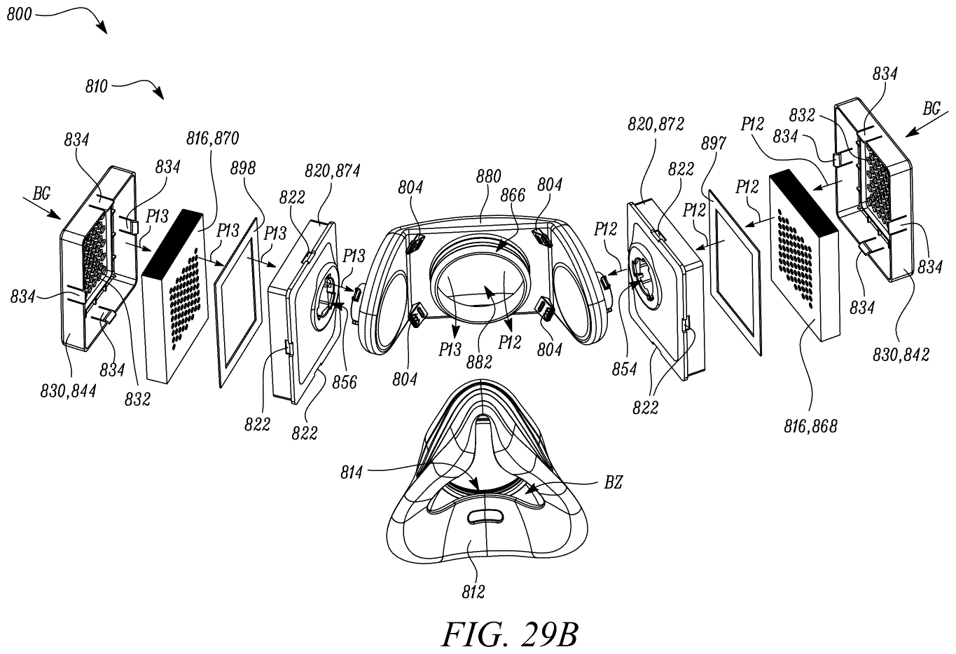

FIG. 28 is a schematic perspective view of a respiratory system 800. The respiratory system 800 may be functionally similar to the respiratory system 700 (shown in FIG. 24), and equivalent reference numbers are used to indicate similar or identical components. The respiratory system 800 includes a respirator 810. The respirator 810 includes a mask body 812 defining the breathable zone BZ (shown in FIGS. 29A and 29B) for a user (e.g., the user 102 shown in FIG. 1).

The respirator 810 further includes at least one housing 820 directly or indirectly coupled to the mask body 812. In the illustrated embodiment of FIG. 28, the at least one housing 820 is indirectly coupled to the mask body 812. Further, the at least one housing 820 includes a first housing 872 and a second housing 874 separate from the first housing 872. The at least one housing 820 is disposed in fluid communication with the breathable zone BZ (shown in FIGS. 29A and 29B) of the mask body 812. Each of the first housing 872 and the second housing 874 is disposed in fluid communication with the breathable zone BZ (shown in FIGS. 25A and 25B) of the mask body 812.

In some examples, the respirator 810 further includes a hub 880 detachably coupled to each of the mask body 812 and the at least one housing 820. In some examples, each of the first housing 872 and the second housing 874 is detachably coupled to the hub 880, such that each of the first housing 872 and the second housing 874 is indirectly coupled to the mask body 812 via the hub 880. In some examples, the respirator 810 further includes at least one strap 804 extending from the hub 880 and configured to be coupled to a head harness (e.g., the head harness 106 shown in FIG. 1) worn by the user. In the illustrated embodiment of FIG. 28, the at least one strap 804 includes a pair of straps 804 disposed proximal to opposing ends of the hub 880. However, it should be understood that the hub 880 may include any number of straps 804.

The respirator 810 further includes at least one cover 830 movably or removably coupled to the at least one housing 820 and including a plurality of cover openings 832 therethrough. In some examples, the at least one cover 830 is removably coupled to the at least one housing 820. In the illustrated embodiment of FIG. 28, the at least one cover 830 further includes a first cover 842 movably coupled to the at least one housing 820. Specifically, the first cover 842 is removably coupled to the first housing 872.

In some examples, the at least one cover 830 further includes a second cover 844 movably coupled to the at least one housing 820 and spaced apart from the first cover 842. Specifically, the second cover 844 is removably coupled to the second housing 874. It should be understood that the first cover 842 and the second cover 844 may be coupled to the respective first housing 872 and the second housing 874 through any other suitable coupling mechanism.

In some examples, the at least one cover 830 (i.e., the first cover 842 and the second cover 844) is stationary relative to the at least one housing 820 (i.e., the first housing 872 and the second housing 826) in the coupled state S1. In some examples, the first cover 842 is further configured to be snap-fitted to the first housing 872 and the second cover 844 is further configured to be snap-fitted to the second housing 874. Specifically, in the coupled state S1, the at least one cover 830 is snap-fitted to the at least one housing 820, i.e., the first cover 842 is snap-fitted to the first housing 872 and the second cover 844 is snap-fitted to the second housing 874.

In some examples, the first cover 842 is substantially similar to the second cover 844. In some examples, the at least one housing 820 (i.e., the first housing 872 and the second housing 874), the first cover 842, and the second cover 844 may be produced using additive manufacturing techniques from a rigid material. In some examples, each of the first cover 842 and the second cover 844 incudes the plurality of cover openings 832 therethrough. Each of the plurality of cover openings 832 is configured to allow the breathable gas BG to flow therethrough.

FIGS. 29A and 29B are schematic front and rear exploded perspective views, respectively, of the respiratory system 800. Referring now to FIGS. 29A and 29B, the respiratory system 800 further includes at least one filter component 816 removably received between the at least one housing 820 and the at least one cover 830. Specifically, the at least one housing 820 and the at least one cover 830 are configured to removably receive at least one filter component 816 therebetween. In some examples, the at least one filter component 816 is P3R-P100 Prototype Particulate Filter Element available from 3M Company, St. Paul, Minn., USA.

In some examples, the first cover 842 and the at least one housing 820 are configured to removably receive a first filter component 868 therebetween. More specifically, the first housing 872 and the first cover 842 removably receive the first filter component 868 therebetween. In some examples, the second cover 844 and the at least one housing 820 are configured to removably receive a second filter component 870 therebetween. Specifically, the second housing 874 and the second cover 844 removably receive the second filter component 870 therebetween. The at least one filter component 816 therefore includes the first filter component 868 and the second filter component 870.

Each of the plurality of cover openings 832 is configured to allow the breathable gas BG to flow therethrough, such that the breathable gas BG passes through the at least one filter component 816 before entering the breathable zone BZ. In some examples, the breathable gas BG passes through each of the first filter component 868 and the second filter component 870 before entering the breathable zone BZ.

In some examples, the respirator 810 further includes a first seal 897 disposed within the first housing 872 between the first filter component 868 and the first housing 872. In some examples, the respirator 810 further includes a second seal 898 disposed within the second housing 874 between the second filter component 870 and the second housing 874. In some examples, each of the first seal 897 and the second seal 898 may be made of a resilient polymeric material, such as rubber, silicone, or the like. The polymeric material may be solid or may be a foam (e.g., an open-cell foam or a closed-cell foam).

In some examples, the first seal 897 may prevent fluid leakage between the first housing 872 and the first filter component 868. In some examples, the second seal 898 may prevent fluid leakage between the second housing 874 and the second filter component 870. In other words, each of the first seal 897 and the second seal 898 may ensure that the breathable gas BG may only reach the breathable zone BZ of the mask body 812 by way of passing through the respective first filter component 868 and the second filter component 870.

In some examples, each of the first seal 897 and the second seal 898 may be permanently attached to the respective first housing 872 and the second housing 874, or it may be removable and replaceable if desired. Alternatively, each of the first seal 897 and the second seal 898 may be provided along with the respective first filter component 868 and the second filter component 870, such that each of the first seal 897 and the second seal 898 may be removed along with the respective first filter component 868 and the second filter component 870 when a new filter component is inserted.

In some examples, the at least one cover 830 further includes one or more first features 834. Specifically, each of the first cover 842 and the second cover 844 includes the one or more first features 834. In some examples, the at least one housing 820 (i.e., the first housing 872 and the second housing 874) includes one or more second features 822 complementary to the one or more first features 834. In some examples, the one the more first features 834 are configured to form a snap-fit connection with the one or more second features 822.

In the illustrated embodiment of FIGS. 29A and 29B, the one or more first features 834 include an elastic tongue and the one or more second features 822 include a groove configured to engage with the elastic tongue in the coupled state S1 (shown in FIG. 28) to form the snap-fit connection. Thus, the snap-fit connection may allow the first cover 842 and the second cover 844 to be removed from the first housing 872 and the second housing 874, thereby enabling replacement of the first filter component 868 and the second filter component 870, respectively.

In some examples, the first housing 872 is detachably coupled to the hub 880 via a first bayonet coupling 884 (shown in FIG. 28). In some examples, the second housing 874 is detachably coupled to the hub 880 via a second bayonet coupling 886 (shown in FIG. 28). However, it should be understood that the first housing 872 and the second housing 874 may be detachably coupled to the hub 880 via any suitable coupling mechanism.

In some examples, the hub 880 includes a first cylindrical portion 888 configured to form the first bayonet coupling 884 with the first housing 872. In some examples, the hub 880 further includes a second cylindrical portion 890 configured to form the second bayonet coupling 886 with the second housing 874. In some examples, each of the first cylindrical portion 888 and the second cylindrical portion 890 includes one or more projections 892 configured to engage with the first housing 872 and the second housing 874 to form the first bayonet coupling 884 and the second bayonet coupling 886, respectively. In some examples, the mask body 812 includes a mask opening 814 extending therethrough and disposed in fluid communication with the breathable zone BZ. In some examples, the hub 880 includes a hub chamber 882 (shown in FIG. 29B) disposed in fluid communication with the mask opening 814. In some examples, the hub 880 further includes a common opening 866 (shown in FIG. 29B) fluidly communicating the hub chamber 882 with the mask opening 814. In some examples, the hub 880 further includes a first hub opening 881 (shown in FIG. 29A) extending therethrough and disposed in fluid communication with the hub chamber 882 and a second hub opening 883 (shown in FIG. 29A) extending therethrough and disposed in fluid communication with the hub chamber 882.

In some examples, the first housing 872 further includes a first housing opening 854 (shown in FIG. 29B) extending therethrough and disposed in fluid communication with the first hub opening 881. In some examples, the second housing 874 further includes a second housing opening 856 (shown in FIG. 29B) extending therethrough and disposed in fluid communication with the second hub opening 883.

In some examples, the breathable gas BG flows through the plurality of cover openings 832 of the first cover 842, passes through the first filter component 868, and then enters the breathable zone BZ through the first housing opening 854, the first hub opening 881, the hub chamber 882, the common opening 866, and the mask opening 814 as shown by flow P12. Further, in some examples, the breathable gas BG flows through the plurality of cover openings 832 of the second cover 844, passes through the second filter component 870, and then enters the breathable zone BZ through the second housing opening 856, the second hub opening 883, the hub chamber 882, the common opening 866, and the mask opening 814 as shown by flow P13.

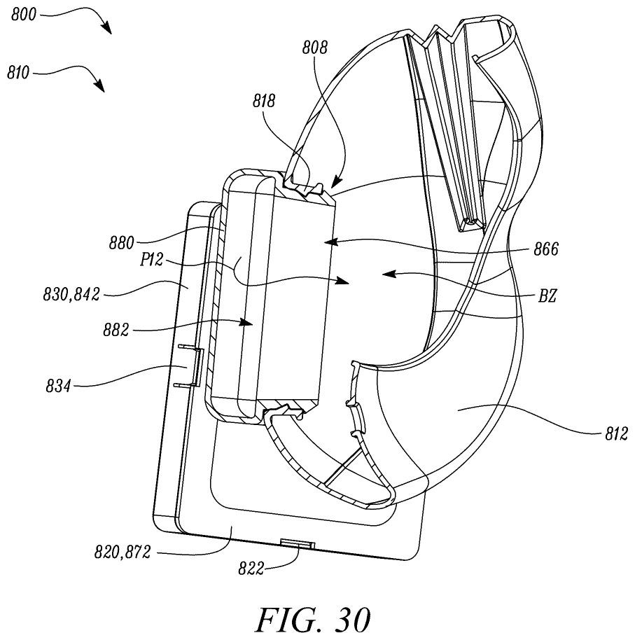

FIG. 30 is a schematic sectional side view of the respiratory system 800. In some examples, at least one of the mask body 812 and the hub 880 includes one or more annular barbs 818 configured to form an annular barbed seal 808 between the mask body 812 and the hub 880. In the illustrated embodiment of FIG. 30, the mask body 812 includes the one or more annular barbs 818 that engages with corresponding features on the hub 880 to form the annular barbed seal 808. In some examples, the annular barbed seal 808 may allow a fluid tight connection between the hub 880 and the mask body 812.

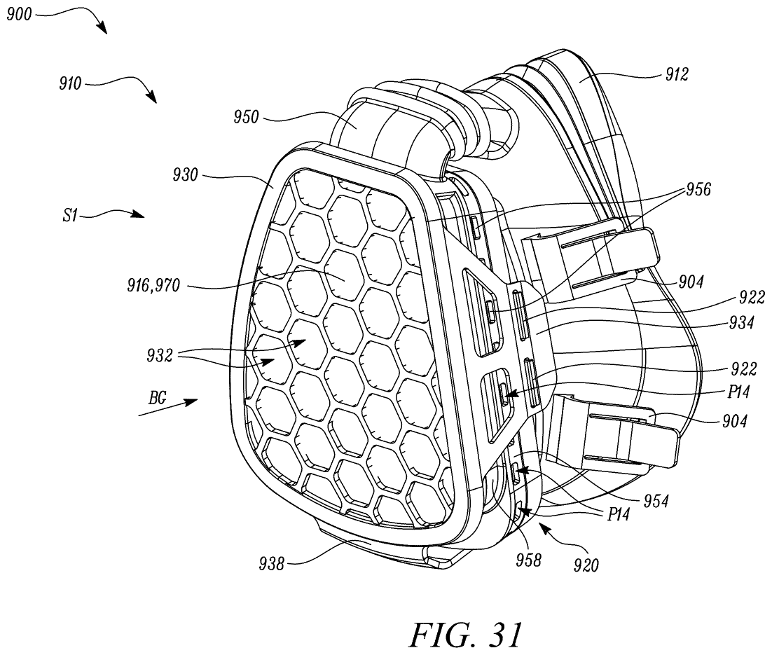

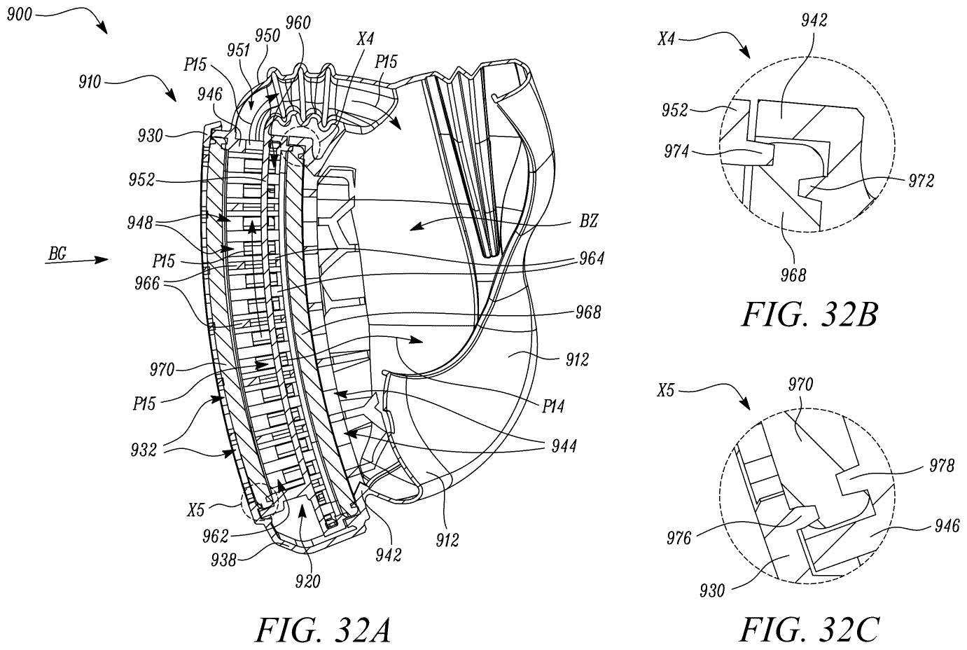

FIG. 31 is a schematic perspective view of a respiratory system 900. The respiratory system 900 may be functionally similar to the respiratory system 100 (shown in FIGS. 1-6B), and equivalent reference numbers are used to indicate similar or identical components. The respiratory system 900 includes a respirator 910. The respirator 910 includes a mask body 912 defining the breathable zone BZ (shown in FIG. 32A) for a user (e.g., the user 102 shown in FIG. 1).

In some examples, the respirator 910 further includes at least one strap 904 extending from the mask body 912 and configured to be coupled to a head harness (e.g., the head harness 106 shown in FIG. 1) worn by the user. In the illustrated embodiment of FIG. 31, the at least one strap 904 includes a pair of straps 904 extending from the respirator 910. However, it should be understood that the respirator 910 may include any number of straps 904.

The respirator 910 further includes at least one housing 920 directly or indirectly coupled to the mask body 912. In the illustrated embodiment of FIG. 31, the at least one housing 920 is directly coupled to the mask body 912. The at least one housing 920 is disposed in fluid communication with the breathable zone BZ of the mask body 912. The respirator 910 further includes at least one cover 930 movably coupled to the at least one housing 920 and including a plurality of cover openings 932 therethrough. Each of the plurality of cover openings 932 is configured to allow the breathable gas BG to flow therethrough. In the illustrated embodiment of FIG. 31, the at least one housing 920 includes a single housing 920 and the at least one cover 930 includes a single cover 930.

In some examples, the mask body 912, the at least one housing 920, and the at least one cover 930 are integrally formed as a unitary part. In some examples, the at least one housing 920, the at least one cover 930, and the mask body 912 may be produced using additive manufacturing techniques. In some examples, the at least one housing 920 and the at least one cover 930 may be made of a rigid material while the mask body 912 may be made of a soft material, such as silicone.

In some examples, the at least one cover 930 is pivotally coupled to the at least one housing 920. In some examples, the respirator 910 further includes a living hinge 938 pivotally coupling the at least one cover 930 to the at least one housing 920. Alternatively, the at least one cover 930 is pivotally coupled to the at least one housing 920 via a pivot connection (e.g., the pivot connection 238 shown in FIGS. 11A-12). However, it should be understood that the at least one cover 930 may be coupled to the at least one housing 920 through any other suitable coupling mechanism. In some examples, the at least one cover 930 is stationary relative to the at least one housing 920 in the coupled state S1. In some examples, in the coupled state S1, the at least one cover 930 is snap-fitted to the at least one housing 920.

In some examples, the at least one cover 930 further includes one or more first features 934. In some examples, the at least one housing 920 includes one or more second features 922 complementary to the one or more first features 934. In some examples, the one the more first features 934 are configured to form a snap-fit connection with the one or more second features 922. In the illustrated embodiment of FIG. 31, the one or more first features 934 include an elastic tongue and the one or more second features 922 include a protrusion. In some examples, the elastic tongue includes at least one groove configured to at least partially receive the protrusion therein to form the snap-fit connection. In some examples, the one or more first features 934 and the one or more second features 922 are disposed on either side of the at least one cover 930.

In some examples, the at least one cover 930 is pivotable relative to the at least one housing 920 in an uncoupled state (not shown). In some examples, in the uncoupled state, the one or more first features 934 are disengaged from the one or more second features 922, thereby enabling the at least one cover 930 to pivot relative to the at least one housing 920.

FIG. 32A is a schematic sectional side view of the respiratory system 900. In some examples, the at least one housing 920 further includes a first wall 942 disposed adjacent to and coupled to the mask body 912. In some examples, the first wall 942 includes a plurality of first openings 944 therethrough. In some examples, the plurality of first openings 944 fluidly communicate with the breathable zone BZ.

In some examples, the at least one housing 920 further includes a second wall 946 spaced apart from the first wall 942 and facing the at least one cover 930. In some examples, the second wall 946 includes a plurality of second openings 948 therethrough. In some examples, the at least one housing 920 further includes a third wall 952 disposed between the first wall 942 and the second wall 946. In some examples, the third wall 952 is devoid of any openings.

In some examples, the at least one housing 920 further includes a first side wall 954 (shown in FIG. 31) extending between the first wall 942 and the third wall 952. In some examples, the first side wall 954 defines a plurality of side openings 956 (shown in FIG. 31) therethrough. In some examples, the at least one housing 920 further includes a second side wall 958 (shown in FIG. 31) extending between the second wall 946 and the third wall 952. In some examples, the second side wall 958 is devoid of any openings. In some examples, the at least one housing 920 further includes a fluid conduit 950 extending between the at least one housing 920 and the mask body 912. The fluid conduit 950 defines a fluid passage 951 therethrough. The fluid passage 951 allows fluid communication between the at least one housing 920 and the mask body 912.

The respiratory system 900 further includes at least one filter component 916 removably received between the at least one housing 920 and the at least one cover 930. Specifically, the at least one housing 920 and the at least one cover 930 are configured to removably receive the at least one filter component 916 therebetween, such that the breathable gas BG passes through the at least one filter component 916 before entering the breathable zone BZ. In some examples, the at least one filter component 916 is 5N11 N95 Particulate Filter available from 3M Company, St. Paul, Minn., USA.

In some examples, the first wall 942, the third wall 952 and the first side wall 954 define a first chamber 960 therebetween. In some examples, the first chamber 960 is configured to removably receive a first filter component 968 therein. In some examples, the plurality of first openings 944 of the first wall 942 fluidly communicate the first chamber 960 with the breathable zone BZ. In some examples, the breathable gas BG enters the first chamber 960 through the plurality of side openings 956 (shown in FIG. 31), passes through the first filter component 968, and then enters the breathable zone BZ through the plurality of first openings 944 as indicated by flow P14. Thus, the breathable gas BG may pass through the first filter component 968 before entering the breathable zone BZ.

In some examples, the second wall 946, the third wall 952, and the second side wall 958 define a second chamber 962 therebetween fluidly separated from the first chamber 960 by the third wall 952. In some examples, the second wall 946 and the at least one cover 930 removably receive a second filter component 970 therebetween. In some examples, the fluid conduit 950 fluidly communicates the second chamber 962 with the breathable zone BZ. In some examples, the breathable gas BG passes through the plurality of cover openings 932 and the second filter component 970, enters the second chamber 962, and then enters the breathable zone BZ through the fluid conduit 950 as indicated by flow P15. The at least one filter component 916 therefore includes the first filter component 968 and the second filter component 970 fluidly separated from the first filter component 968 by the third wall 952.

In some examples, the fluid conduit 950 fluidly communicates only the second chamber 962 with the breathable zone BZ and not the first chamber 960. Further, the flow P15 is separate from the flow P14 since the second chamber 962 is fluidly separated from the first chamber 960 by the third wall 952. Specifically, the flow P15 enters the breathable zone BZ through the fluid conduit 950 while the flow P14 enters the breathable zone BZ through the plurality of first openings 944. Thus, the respirator 910 may allow filtration of the breathable gas BG through two separate filter components (i.e., the first filter component 968 and the second filter component 970). Further, the respirator 910 may allow the first filter component 968 and the second filter component 970 to be stacked together, such that an overall size of the respirator 910 may be reduced while maintain a required filtration efficiency of the respirator 910.

FIG. 32B is an enlarged schematic view of a section X4 (shown in FIG. 32A) of the respiratory system 900. Referring now to FIGS. 32A and 32B, in some examples, the at least one housing 920 further includes a first continuous knife edge seal 972 extending from the first wall 942 towards the third wall 952 and configured to engage with the first filter component 968. In some examples, the at least one housing 920 further includes a second continuous knife edge seal 974 spaced apart from the first continuous knife edge seal 972 and extending from the third wall 952 towards the first wall 942. In some examples, the second continuous knife edge seal 974 is configured to engage with the first filter component 968. In some examples, the first continuous knife edge seal 972 and the second continuous knife edge seal 974 may secure the first filter component 968 in place between the first wall 942 and the third wall 952.

FIG. 32C is an enlarged schematic view of a section X5 (shown in FIG. 32A) of the respiratory system 900. Referring now to FIGS. 32A and 32C, in some examples, the at least one cover 930 further includes a third continuous knife edge seal 976 extending from the at least one cover 930 towards the second wall 946 and configured to engage with the second filter component 970. In some examples, the at least one housing 920 further includes a fourth continuous knife edge seal 978 spaced apart from the third continuous knife edge seal 976 and extending from the second wall 946 towards the at least one cover 930. In some examples, the fourth continuous knife edge seal 978 is configured to engage with the second filter component 970. In some examples, the third continuous knife edge seal 976 and the fourth continuous knife edge seal 978 may secure the second filter component 970 in place between the at least one cover 930 and the second wall 946.

In some examples, the at least one cover 930 may be pivoted relative to the at least one housing 920 through the living hinge 938 after disengaging the one or more first features 934 (shown in FIG. 31) from the one or more second features 922 (shown in FIG. 31) to access the second filter component 970. Further, the second wall 946 and the third wall 952 are rotatable relative to the first wall 942 and the mask body 912 upon disengagement of the one or more first features 934 from the one or more second features 922. In some examples, the second wall 946 and the third wall 952 are connected to the fluid conduit 950, thereby allowing the second wall 946 and the third wall 952 (and the second chamber 962) to rotate relative to the first wall 942 and the mask body 912. Thus, the respiratory system 900 may allow access to the first filter component 968 upon rotation of the second wall 946 and the third wall 952 relative to the first wall 942 and the mask body 912.

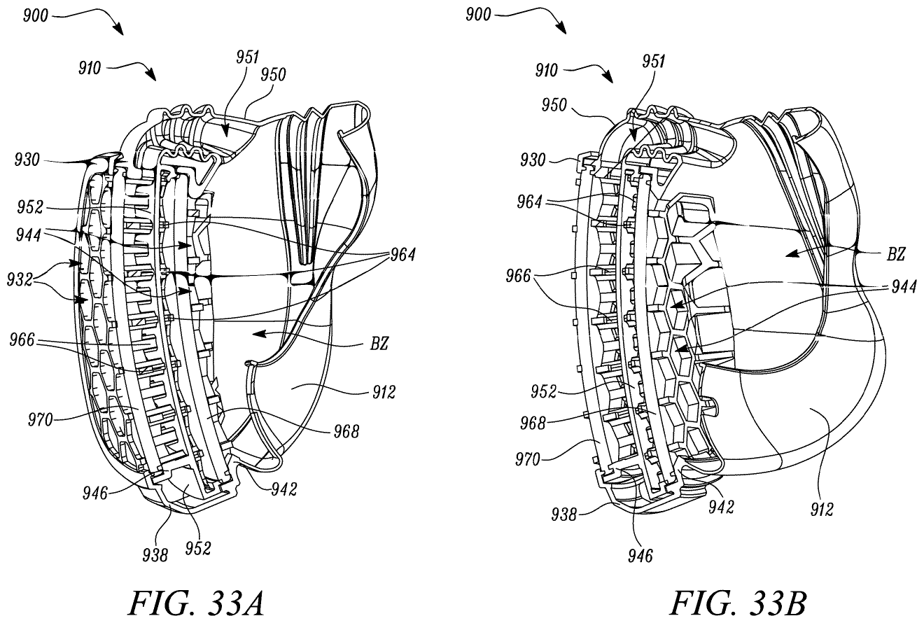

FIGS. 33A and 33B are schematic front and rear perspective sectional views of the respiratory system 900, respectively. Referring now to FIGS. 32A, 33A and 33B, in some examples, the at least one housing 920 further includes a plurality of first projections 964 extending from the third wall 952 at least partially towards the first wall 942. In some examples, each of the plurality of first projections 964 is configured to engage the first filter component 968. In some examples, the at least one housing 920 further includes a plurality of second projections 966 extending between the third wall 952 and the second wall 946. In some examples, the plurality of second projections 966 may determine a height of the second chamber 962. In some examples, the plurality of first projections 964 and the plurality of second projections 966 may enhance a flow of the breathable gas BG through the first chamber 960 and the second chamber 962, respectively.

Referring now to FIGS. 1-33B, the respirator 110, 210, 310, 410, 510, 610, 710, 810, 910 of the present disclosure may allow the at least one filter component 116, 216, 316, 416, 516, 616, 716, 816, 916 to be removably received between the at least one housing 120, 220, 320, 420, 520, 620, 720, 820, 920 and the at least one cover 130, 230, 330, 430, 530, 630, 730, 830, 930, thereby enabling the respirator 110, 210, 310, 410, 510, 610, 710, 810, 910 to be reused by replacing the at least one filter component 116, 216, 316, 416, 516, 616, 716, 816, 916. Further, a variety of filter components that are suitable for different applications may be used with a common design of the respirator 110, 210, 310, 410, 510, 610, 710, 810, 910. Additionally, the respirator 110, 210, 310, 410, 510, 610, 710, 810, 910 of the present disclosure may be additively manufactured in whole or in part and may enable the respirator to be readily printed across multiple commercial printer platforms.

Although features have been described with reference to certain embodiments, those features may also be present in other embodiments whether described or not. For example, the pivot connection 238 described with reference to FIGS. 11A-12 mayalso be present in other respirators 110, 310, 410, 510, 710, 910. Further, the at least one strap 704 described with reference to FIGS. 27A and 27B may also be applicable to all the respirators 110, 210, 310, 410, 510, 610, 710, 810, 910.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components, or layers for example.

Various examples have been described. These and other examples are within the scope of the following claims.

1. A respirator comprising:
a mask body defining a breathable zone for a user;
at least one housing directly or indirectly coupled to the mask body, wherein the at least one housing is disposed in fluid communication with the breathable zone of the mask body, the at least one housing comprising:
a pair of slots spaced apart from each other, each of the pair of slots comprising a first slot end and a second slot end;
a cantilevered snap feature disposed between the pair of slots; and
a latch connected to the cantilevered snap feature and configured to move the cantilevered snap feature upon application of a force on the latch; and
at least one cover movably coupled to the at least one housing and comprising:
a plurality of cover openings therethrough, wherein each of the plurality of cover openings is configured to allow a breathable gas to flow therethrough;
a pair of arms, each of the pair of arms disposed adjacent to a corresponding slot from the pair of slots, each of the pair of arms comprising a wide end portion comprising a maximum width greater than a maximum width of the corresponding slot; and
an elongate member extending between the pair of arms and connected to the wide end portion of each of the pair of arms, wherein the elongate member is at least partially received through each of the pair of slots;
wherein the at least one housing and the at least one cover are configured to removably receive at least one filter component therebetween, such that the breathable gas passes through the at least one filter component before entering the breathable zone.

2. The respirator of claim 1, wherein:
the at least one cover is pivotable relative to the at least one housing, wherein the elongate member is disposed proximal to the first slot end of each of the pair of slots;
the elongate member is configured to be slidably moved along each of the pair of slots towards the second slot end of each of the pair of slots; and
upon movement of the elongate member towards the second slot end of each of the pair of slots, the elongate member is snap-fitted to the cantilevered snap feature, thereby preventing relative slidable movement between the elongate member and each of the pair of slots.

3. The respirator of claim 1, wherein the at least one housing further comprises:
a first wall disposed adjacent to and coupled to the mask body, the first wall comprising a plurality of first openings therethrough, wherein the plurality of first openings fluidly communicate with the breathable zone;
a second wall spaced apart from the first wall and facing the at least one cover, wherein the second wall comprises a plurality of second openings therethrough;
a third wall disposed between the first wall and the second wall, wherein the third wall is devoid of any openings;
a first side wall extending between the first wall and the third wall, wherein the first side wall defines a plurality of side openings therethrough;
a second side wall extending between the second wall and the third wall, wherein the second side wall is devoid of any openings; and
a fluid conduit extending between the at least one housing and the mask body;
wherein:
the first wall, the third wall and the first side wall define a first chamber therebetween;
the plurality of first openings of the first wall fluidly communicate the first chamber with the breathable zone;
the first chamber is configured to removably receive a first filter component therein;
the breathable gas enters the first chamber through the plurality of side openings, passes through the first filter component, and then enters the breathable zone through the plurality of first openings;
the second wall, the third wall, and the second side wall define a second chamber therebetween fluidly separated from the first chamber by the third wall;
the fluid conduit fluidly communicates the second chamber with the breathable zone;
the second wall and the at least one cover removably receive a second filter component therebetween; and
the breathable gas passes through the plurality of cover openings and the second filter component, enters the second chamber, and then enters the breathable zone through the fluid conduit.

4. The respirator of claim 1, wherein the at least one cover further comprises:
a first cover movably coupled to the at least one housing, wherein the first cover and the at least one housing are configured to removably receive a first filter component therebetween; and
a second cover movably coupled to the at least one housing and spaced apart from the first cover, wherein the second cover and the at least one housing are configured to removably receive a second filter component therebetween.

5. The respirator of claim 4, wherein the at least one housing further comprises a single housing comprising a curved shape, and wherein the single housing extends between a first housing end and a second housing end opposite to the first housing end.

6. The respirator of claim 5, wherein the single housing further comprises a first wall facing each of the first cover and the second cover, and wherein the first wall comprises:
a first opening extending therethrough and at least partially aligned with the first cover, wherein the first opening is disposed in fluid communication with the breathable zone; and
a second opening extending therethrough and spaced apart from the first opening, wherein the second opening is at least partially aligned with the second cover, and wherein the second opening is disposed in fluid communication with the breathable zone.

7. The respirator of claim 4, wherein the at least one housing further comprises:
a first housing, wherein the first cover is movably coupled to the first housing, and wherein the first housing and the first cover removably receive the first filter component therebetween; and
a second housing separate from the first housing, wherein the second cover is movably coupled to the second housing, and wherein the second housing and the second cover removably receive the second filter component therebetween.

8. The respirator of claim 1, wherein the at least one housing further comprises a single housing, wherein the at least one cover further comprises a single cover, and wherein the single housing and the single cover are configured to removably receive the at least one filter component therebetween.

9. The respirator of claim 1, wherein the at least one cover further comprises one or more first features, wherein the at least one housing further comprises one or more second features complementary to the one or more first features, and wherein the one the more first features are configured to form a snap-fit connection with the one or more second features.

10. The respirator of claim 1, wherein the at least one cover further comprises one or more first features, wherein the mask body further comprises one or more second features complementary to the one or more first features, and wherein the one the more first features are configured to form a snap-fit connection with the one or more second features.

11. The respirator of claim 1, wherein the at least one cover is pivotally coupled to the at least one housing, wherein the at least one cover is pivotable relative to the at least one housing in an uncoupled state, wherein the at least one cover is stationary relative to the at least one housing in a coupled state, and wherein, in the coupled state, the at least one cover is snap-fitted to the at least one housing.

12. The respirator of claim 1, wherein the at least one cover further comprises a continuous cover knife edge seal configured to engage with the at least one filter component, and wherein the at least one housing further comprises a continuous housing knife edge seal spaced apart from the continuous cover knife edge seal and configured to engage with the at least one filter component.

13. A respiratory system comprising:
the respirator of claim 1; and
at least one filter component removably received between the at least one housing and the at least one cover.

14. A respirator comprising:
a mask body defining a breathable zone for a user;
at least one housing directly or indirectly coupled to the mask body, wherein the at least one housing is disposed in fluid communication with the breathable zone of the mask body; and
at least one cover removably coupled to the at least one housing and comprising a plurality of cover openings therethrough, wherein each of the plurality of cover openings is configured to allow a breathable gas to flow therethrough;
wherein the at least one housing and the at least one cover are configured to removably receive at least one filter component therebetween, such that the breathable gas passes through the at least one filter component before entering the breathable zone;
wherein at least one of the mask body and the at least one housing comprises one or more annular barbs configured to form an annular barbed seal between the mask body and the at least one housing.

15. The respirator of claim 14, wherein the at least one housing further comprises a single housing, wherein the at least one cover further comprises a single cover, and wherein the single housing and the single cover are configured to removably receive the at least one filter component therebetween.

16. The respirator of claim 14, wherein the at least one cover further comprises:
a first cover removably coupled to the at least one housing, wherein the first cover and the at least one housing are configured to removably receive a first filter component therebetween; and
a second cover removably coupled to the at least one housing and spaced apart from the first cover, wherein the second cover and the at least one housing are configured to removably receive a second filter component therebetween.

17. The respirator of claim16, wherein the at least one housing further comprises:
a first housing, wherein the first cover is removably coupled to the first housing, and wherein the first housing and the first cover removably receive the first filter component therebetween; and
a second housing separate from the first housing, wherein the second cover is removably coupled to the second housing, and wherein the second housing and the second cover removably receive the second filter component therebetween.

18. The respirator of claim 14, wherein the at least one cover further comprises one or more first features, wherein the at least one housing further comprises one or more second features complementary to the one or more first features, and wherein the one the more first features are configured to form a snap-fit connection with the one or more second features.

19. The respirator of claim 14, wherein the at least one cover further comprises a continuous cover knife edge seal configured to engage with the at least one filter component, and wherein the at least one housing further comprises a continuous housing knife edge seal spaced apart from the continuous cover knife edge seal and configured to engage with the at least one filter component.

20. A respiratory system comprising:
the respirator of claim 14; and
at least one filter component removably received between the at least one housing and the at least one cover.
